(19) United States
(12) Patent Application Publication
(10) Pub. No.: US 2026/0280152 A1
(43) Pub. Date: Sep. 17, 2026

(54) TERMINAL ANTENNA SYSTEM

(71) Applicant: HONOR DEVICE CO., LTD., Shenzhen (CN)

(72) Inventors: Dawei ZHOU, Shenzhen (CN); Yuanpeng Li, Shenzhen (CN)

(21) Appl. No.: 18/877,328

(22) PCT Filed: Nov. 14, 2023
(86) PCT No.: PCT/CN2023/131509

§ 371 Date: Dec. 20, 2024

(30) Foreign Application Priority Data
Jan. 13, 2023 (CN) 202310083904.4

(51) Int. Cl. H01Q 21/28; H01Q 1/24; H01Q 9/42; H01Q 21/00

(52) U.S. Cl. CPC H01Q 21/28; H01Q 1/243; H01Q 9/42; H01Q 21/0006

(57) ABSTRACT

Embodiments of this application disclose a terminal antenna system. The first antenna includes a first radiator, the second antenna includes a second radiator, and lengths of the first radiator and the second radiator are less than or equal to one-half of a wavelength corresponding to a first frequency band. A first feed point and a second feed point are respectively arranged at two ends of the first radiator and are respectively coupled to two signal output ends of a common mode feed structure. The two signal output ends have a same polarity. Two signals are equi-amplitude in-phase signals. A third feed point and a fourth feed point are arranged at two ends of the second radiator and are respectively coupled to two signal output ends of a differential mode feed structure. The two signal output ends have different polarities. Two signals are equi-amplitude phase-inverted signals.

This application claims priority to Chinese Patent Application No. 202310083904.4, filed with the China National Intellectual Property Administration on Jan. 13, 2023 and entitled “TERMINAL ANTENNA SYSTEM”, which is incorporated herein by reference in its entirety.

### TECHNICAL FIELD

This application relates to the field of antenna technologies, and in particular, to a terminal antenna system.

### BACKGROUND

In an electronic device, a plurality of antennas may be arranged, to support increasing wireless communication requirements of the electronic device. When operating simultaneously, the plurality of antennas may interfere with one another. Consequently, overall radiation performance of the electronic device is affected. By increasing isolation between the plurality of antennas, impact of the plurality of antennas on one another in an operating process can be effectively reduced.

### SUMMARY

Embodiments of this application provide a terminal antenna system. The terminal antenna system may include a first antenna and a second antenna. In combination with different operating mechanisms of the first antenna and the second antenna and specific position restriction, the two antennas are arranged with high isolation. In this way, the terminal antenna system can provide relatively good radiation performance in an operating frequency band.

To achieve the foregoing objective, the following technical solutions are applied to embodiments of this application.

According to a first aspect, a terminal antenna system with high isolation is provided, and is used in an electronic device. The terminal antenna system includes a first antenna and a second antenna. Operating frequency bands of the first antenna and the second antenna both include a first frequency band. The first antenna includes a first radiator, and a length of the first radiator is less than or equal to one-half of a wavelength corresponding to the first frequency band. A first feed point and a second feed point are respectively arranged at two ends of the first radiator. The first feed point and the second feed point are respectively coupled to two signal output ends of a common mode feed structure. The two signal output ends have a same polarity. Two signals are equi-amplitude in-phase signals. The second antenna includes a second radiator, and a length of the second radiator is less than or equal to one-half of the wavelength corresponding to the first frequency band. A third feed point and a fourth feed point are respectively arranged at two ends of the second radiator. The third feed point and the fourth feed point are respectively coupled to two signal output ends of a differential mode feed structure. The two signal output ends have different polarities. Two signals are equi-amplitude phase-inverted signals.

Based on this solution, specific composition restriction of the first antenna and the second antenna is provided. It may be understood that the first antenna and the second antenna implement respective corresponding radiation based on different feeding forms. Correspondingly, the first antenna and the second antenna may have different respective radiation features, for example, current distribution on the radiators is different, and for another example, current distribution on a reference ground is different. In this way, the two antennas can have relatively good isolation while simultaneously providing radiation in the first frequency band, so that the terminal antenna system can provide relatively good overall radio performance coverage in the first frequency band when the two antennas simultaneously provide relatively good radiation performance.

Optionally, the length of the first radiator is less than one-half of the wavelength corresponding to the first frequency band, or the length of the first radiator is less than or equal to one-fourth of the wavelength corresponding to the first frequency band. A smaller size of the first radiator corresponds to better radiation performance of the first antenna.

Optionally, the length of the second radiator is less than one-half of the wavelength corresponding to the first frequency band, or the length of the second radiator is less than or equal to one-fourth of the wavelength corresponding to the second frequency band. A smaller size of the second radiator corresponds to better radiation performance of the second antenna.

Optionally, the first antenna and the second antenna are jointly or separately arranged. The following examples provide several different examples of positions on which the first antenna and the second antenna are arranged on the electronic device. In all of the examples, the first antenna and the second antenna may have relatively good isolation.

Optionally, when the first antenna and the second antenna are jointly arranged, the first radiator and the second radiator share a same radiator, the first feed point and the third feed point are arranged close to each other, and the second feed point and the fourth feed point are arranged close to each other.

Optionally, the first radiator and the second radiator are two different radiators when the first antenna and the second antenna are separately arranged.

Optionally, the first antenna is arranged on a first edge of the electronic device, the second antenna is arranged on the first edge of the electronic device, and projection of the first radiator and projection of the second radiator onto the first edge do not overlap each other. This is series connection distribution. Alternatively, the first antenna is arranged on a first edge of the electronic device, the second antenna is arranged on a second edge of the electronic device, and the first edge and the second edge are two adjacent edges. This is orthogonal distribution. Alternatively, the first antenna is arranged on a first edge of the electronic device, the second antenna is arranged on a third edge of the electronic device, and the first edge and the third edge are opposite edges. This is opposite distribution. Alternatively, the first antenna is arranged on a first edge of the electronic device, the second antenna is arranged on the first edge of the electronic device, and projection of the first radiator and projection of the second radiator onto the first edge at least partially overlap. This is parallel connection distribution.

Optionally, the first feed point and the second feed point of the first radiator are respectively coupled to two signal output ends of a first differential mode feed structure, instead of the two signal output ends of the common mode feed structure, the two signal output ends of the first differential mode feed structure have different polarities, and two signals of the first differential mode feed structure are equi-amplitude phase-inverted signals.

Optionally, the third feed point and the fourth feed point of the second radiator are respectively coupled to two signal output ends of a first common mode feed structure, instead of the two signal output ends of the differential mode feed structure, the two signal output ends of the first common mode feed structure have a same polarity, and two signals of the first common mode feed structure are equi-amplitude in-phase signals.

In this case, two feed arrangement examples of the first antenna and the second antenna are provided.

Optionally, a current reversal point is distributed on the first radiator when the first antenna operates. When the second antenna operates, same-direction currents are distributed on the second radiator, and there is no current reversal point. Therefore, current distribution on the radiators of the first antenna and the second antenna is different.

Optionally, the length of the first radiator is less than one-half of the wavelength of the first frequency band. A maximum electric field amplitude difference between the first radiator and a reference ground is a first value. The maximum electric field amplitude difference between the first radiator and the reference ground is a second value when the length of the first radiator is replaced with one-half of the wavelength of the first frequency band. The first value is less than the second value.

Optionally, the length of the second radiator is less than one-half of the wavelength of the first frequency band. A maximum current amplitude difference on the second radiator is a third value when the second antenna operates. The maximum current amplitude difference on the second radiator is a fourth value when the length of the second radiator is replaced with one-half of the wavelength of the first frequency band. The third value is less than the fourth value.

Optionally, the first radiator and the second radiator are arranged on a first edge of the electronic device. A current perpendicular to a straight line on which the first edge is located on a reference ground is excited when the first antenna operates. A current parallel to the straight line on which the first edge is located on the reference ground is excited when the second antenna operates. Therefore, currents excited on a floor when the first antenna and the second antenna operate also have an orthogonal characteristic.

Because current distribution on the radiators of the first antenna and the second antenna is different, and current distribution on the reference ground is also different, the first antenna and the second antenna may have relatively good isolation, to perform radiation without interfering with each other.

According to a second aspect, an electronic device is provided. The electronic device is provided with the terminal antenna system according to any one of the first aspect and the possible implementations of the first aspect. When transmitting or receiving a signal, the electronic device transmits or receives the signal through the terminal antenna system.

According to a third aspect, a foldable electronic device is provided. The foldable electronic device includes the foregoing terminal antenna system. The foldable electronic device includes a first portion and a second portion that are connected to each other and that can be folded or unfolded opposite to each other, the first antenna is arranged on the first portion of the foldable electronic device, and the second antenna is arranged on the second portion of the foldable electronic device. The first antenna and the second antenna at least partially overlap when the foldable electronic device is in a closed state.

It should be understood that the technical features of the technical solutions provided in the second aspect and the third aspect above can correspond to the solutions provided in the first aspect and the possible designs of the first aspect, and therefore similar beneficial effects can be achieved. Details are not described herein.

### BRIEF DESCRIPTION OF DRAWINGS

FIG. 1 is a diagram of a multi-antenna arrangement in an electronic device;

FIG. 2 is a diagram of composition of an electronic device according to an embodiment of this application;

FIG. 3 is a diagram of an architecture of a metal bezel according to an embodiment of this application;

FIG. 4 is a diagram of logical composition of an electronic device according to an embodiment of this application;

FIG. 5 is a diagram of composition of an antenna system according to an embodiment of this application;

FIG. 6 is a diagram of composition of a first antenna according to an embodiment of this application;

FIG. 7 is a diagram of operation of a first antenna according to an embodiment of this application;

FIG. 8 is a diagram of composition of a second antenna according to an embodiment of this application;

FIG. 9 is a diagram of operation of a second antenna according to an embodiment of this application;

FIG. 10 is a diagram of logical division of a multi-antenna position relationship according to an embodiment of this application;

FIG. 11 is a diagram of series connection distribution according to an embodiment of this application;

FIG. 12 is a diagram of parallel connection distribution according to an embodiment of this application;

FIG. 13 is a diagram of opposite distribution according to an embodiment of this application;

FIG. 14 is a diagram of orthogonal distribution according to an embodiment of this application;

FIG. 15 is a diagram of an exciting effect of a current on a floor during series connection distribution according to an embodiment of this application;

FIG. 16 is a diagram of an exciting effect of a current on a floor during parallel connection distribution according to an embodiment of this application;

FIG. 17 is a diagram of parallel connection distribution in a joint arrangement according to an embodiment of this application;

FIG. 18 is a diagram of simulation of an S parameter according to an embodiment of this application;

FIG. 19 is a diagram of simulation of efficiency according to an embodiment of this application;

FIG. 20 is a diagram of current simulation of a first antenna according to an embodiment of this application;

FIG. 21 is a diagram of current simulation of a second antenna according to an embodiment of this application;

FIG. 22 is a diagram of electric field simulation of a first antenna according to an embodiment of this application;

FIG. 23 is a diagram of electric field simulation of a second antenna according to an embodiment of this application;

FIG. 24 is a diagram of simulation of a pattern of a first antenna according to an embodiment of this application;

FIG. 25 is a diagram of simulation of a pattern of a second antenna according to an embodiment of this application;

FIG. 26 is a diagram of a foldable device according to an embodiment of this application; and

FIG. 27 is a diagram of arrangement of a multi-antenna in a foldable device according to an embodiment of this application.

### DESCRIPTION OF EMBODIMENTS

With the development of wireless communication technologies, a plurality of antennas usually need to be arranged in an electronic device, to meet a requirement of the electronic device on a wireless communication function. Operating frequency bands of some antennas may partially overlap or completely overlap, to improve a communication capability of a corresponding frequency band.

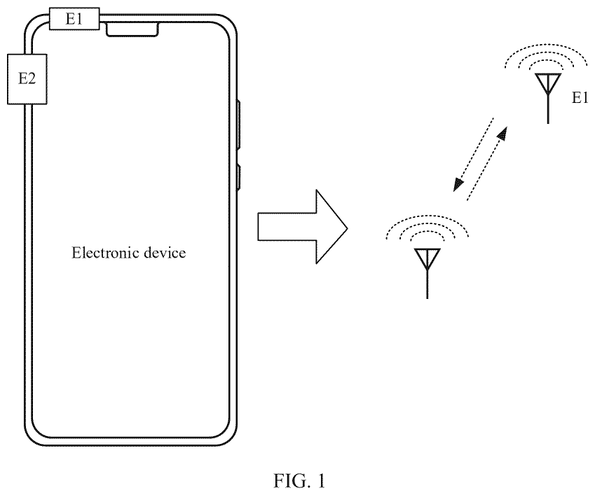

Refer to FIG. 1. That antennas arranged in an electronic device include E1 and E2, and operating frequency bands of E1 and E2 both include a frequency band 1 is used as an example.

In some scenarios, the electronic device may use E1 to send a signal in the frequency band 1, and the electronic device may further use E2 to receive the signal in the frequency band 1.

It may be understood that because E1 and E2 both operate in the frequency band 1, signals received by E2 may include the signal sent by E1. However, the signal clearly does not need to be received by the electronic device. In other words, when E1 and E2 operate simultaneously, mutual impact may occur between the two antennas. Consequently, wireless communication efficiency of the antennas is reduced.

In the foregoing example, a scenario in which E1 performs transmission and E2 performs receiving is used as an example. In another scenario, a similar problem may also exist, reducing wireless communication efficiency of the antennas. For example, a same problem may also be generated due to a similar mechanism in a scenario in which E1 performs receiving and E2 performs transmission. In addition, an example in which the operating frequency band of E1 is lower than the operating frequency band of E2 is used when the operating frequency bands of E1 and E2 are different. Although the operating frequency band of E1 does not overlap that of E2, corresponding frequency multiplication of resonance during operation of E1 may also affect operation of E2.

To resolve a problem of mutual impact in a multi-antenna scenario, impact between the antennas may be reduced by increasing isolation between the antennas. The better the isolation between the antennas, the smaller the mutual impact between the antennas. The isolation may be identified by a normalized value.

Two-port isolation is used as an example. The isolation may be identified by S21 (or S12) in an S parameter Values of S21 at different frequencies correspond to two-port isolation at current frequencies. After normalization, a maximum value of isolation does not exceed 0. A larger absolute value of isolation indicates better corresponding isolation and smaller impact between the antennas. On the contrary, a smaller absolute value of isolation indicates poorer isolation and larger impact between the antennas.

It should be understood that strength of radiation performance of the antennas also affects the isolation between the antennas. Still refer to the foregoing example shown in FIG. 1. When mutual impact exists between E1 and E2, when other impact is not considered, better radiation performance of the antennas indicates poorer isolation and greater mutual impact between the antennas. For example, better radiation performance of E1 indicates poorer isolation between E1 and E2 at a frequency or in a frequency band with relatively good radiation performance. However, to ensure a wireless communication function of the electronic device, the antennas are required to provide relatively good radiation performance. In other words, the antennas in the electronic device need to provide relatively good radiation performance and need to have relatively good antenna isolation. This places a relatively high requirement on a multi-antenna design in the electronic device.

To resolve the foregoing problems, embodiments of this application provide a high isolation antenna system including at least two antennas, so that each antenna can have relatively good isolation while providing relatively good radiation performance. When the high isolation antenna system is used in a terminal device, the high isolation antenna system may also be referred to as a high isolation terminal antenna system.

In subsequent descriptions, composition and a radiation status of the high isolation antenna system provided in embodiments of this application are separately described by way of example. The radiation status may be identified by radiation efficiency and/or system efficiency. The radiation efficiency may identify a maximum radiation capability of the antenna system, and the system efficiency identifies an efficiency status that the antenna can provide under a current environment and current port matching.

The following first describes an implementation scenario of a high isolation antenna solution provided in embodiments of this application.

The antenna solution provided in embodiments of this application may be applied to an electronic device of a user, to support a wireless communication function of the electronic device. For example, the electronic device may be a portable mobile device such as a mobile phone, a tablet computer, a personal digital assistant (personal digital assistant, PDA), an augmented reality (augmented reality, AR)/virtual reality (virtual reality, VR) device, and a media player, or the electronic device may be a wearable electronic device such as a smartwatch. A specific form of the device is not particularly limited in embodiments of this application.

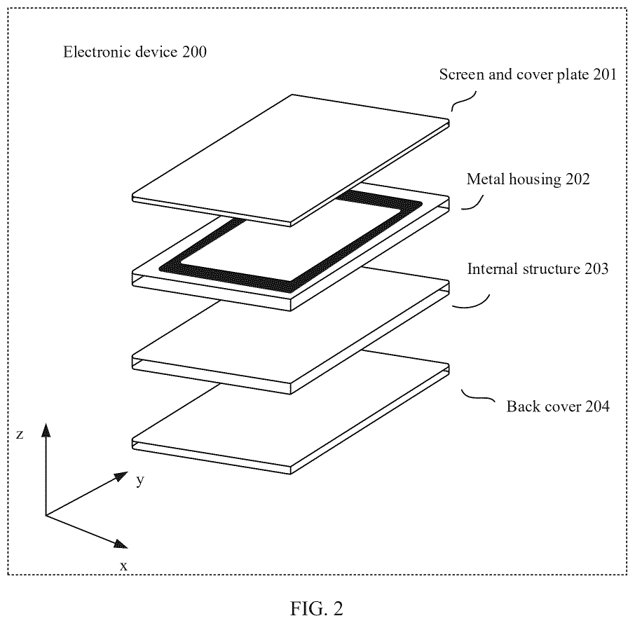

FIG. 2 is a diagram of a structure of an electronic device 200 according to an embodiment of this application. As shown in FIG. 2, in the electronic device 200 provided in this embodiment of this application, a screen and a cover plate 201, a metal housing 202, an internal structure 203, and a back cover 204 may be sequentially arranged in top to bottom order along a z-axis.

The screen and the cover plate 201 may be configured to implement a display function of the electronic device 200. The metal housing 202 may serve as a body frame of the electronic device 200 to provide rigid support for the electronic device 200. The internal structure 203 may include a set of electronic components and mechanical components that implement functions of the electronic device 200. For example, the internal structure 203 may include a shielding case, a screw, a rib, or the like. The back cover 204 may be a back appearance surface of the electronic device 200. A glass material, a ceramic material, a plastic, or the like may be used for the back cover 204 in different implementations.

The antenna solution provided in embodiments of this application can be applied to the electronic device 200 shown in FIG. 2, to support a wireless communication function of the electronic device 200. In some embodiments, an antenna in the antenna solution may be arranged on the metal housing 202 of the electronic device 200. In some other embodiments, an antenna in the antenna solution may be arranged on the back cover 204 of the electronic device 200, or the like.

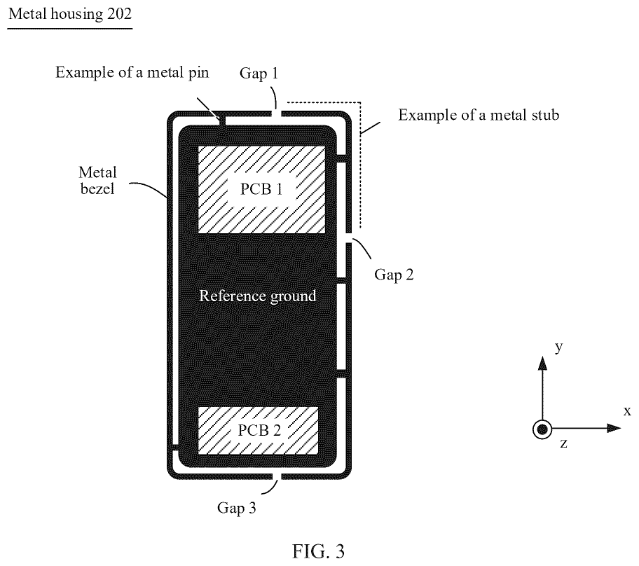

In an example, that the metal housing 202 has a metal bezel architecture is used as an example. FIG. 3 shows schematic composition of a metal housing 202. In this example, a metal material, for example, aluminum alloy, may be used for the metal housing 202. As shown in FIG. 3, a reference ground may be arranged on the metal housing 202. The reference ground may be a metal material having a relatively large area, and is configured to provide most rigid support and provide a zero potential reference for various electronic components. In the example shown in FIG. 3, a metal bezel may be further arranged on a periphery of the reference ground. The metal bezel may be a complete closed metal bezel. The metal bezel may include a metal strip that is partially or entirely suspended. In some other implementations, the metal bezel may alternatively be a metal bezel broken by one or more gaps as shown in FIG. 3. For example, in the example in FIG. 3, a gap 1, a gap 2, and a gap 3 may be respectively arranged at different positions on the metal bezel. These gaps can break the metal bezel, to obtain independent metal stubs. In some embodiments, some or all of these metal stubs may be used as radiation stubs of an antenna, to implement structural reuse during antenna arrangement and reduce difficulty of the antenna arrangement. When the metal stub is used as the radiation stub of the antenna, positions of gaps correspondingly arranged at one or two ends of the metal stub may be flexibly selected based on arrangement of the antenna.

In the example shown in FIG. 3, one or more metal pins may be further arranged on the metal bezel. In some examples, the metal pin may be provided with a screw hole for fastening another structural part by using a screw. In some other examples, the metal pin may be coupled to a feed point, so that the antenna is fed through the metal pin when a metal stub connected to the metal pin is used as a radiation stub of the antenna. In some other examples, the metal pin may alternatively be coupled to another electronic component to implement a corresponding electrical connection function. In this embodiment of this application, coupling may be used to refer to a direct electrical connection, may be used to refer to an electrical connection performed through an electronic component and/or an electronic circuit, or may be used to refer to an electrical connection performed through spatial electromagnetic coupling.

In this example, schematic arrangement of a printed circuit board (printed circuit board, PCB) on the metal housing is also shown. A split board design of a main board (main board) and a sub-board (sub-board) is used as an example. In some other examples, the main board and the sub-board may alternatively be connected, for example, provided as an L-shaped PCB design. In some embodiments of this application, the main board (for example, a PCB 1) may be configured to carry electronic components that implement various functions of the electronic device 200, for example, a processor, a memory, a radio frequency module, or the like. The sub-board (for example, a PCB 2) may also be configured to carry electronic components, for example, a universal serial bus (Universal Serial Bus, USB) interface and a related circuit, a speak box (speak box), and the like. For another example, the sub-board may alternatively be configured to carry a radio frequency circuit corresponding to an antenna arranged on a bottom portion (that is, a portion in a negative direction of a y-axis of the electronic device).

The antenna solution provided in embodiments of this application can be applied to the electronic device having the composition shown in FIG. 2 or FIG. 3.

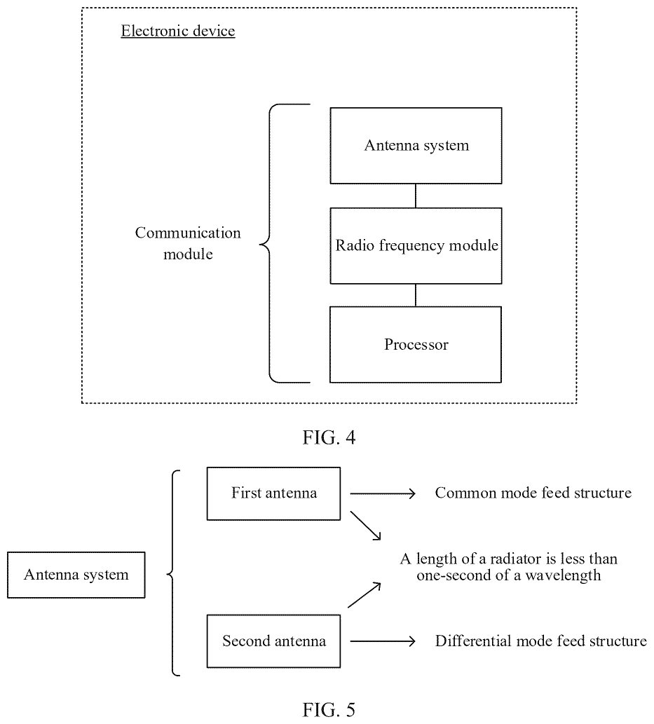

It should be noted that the electronic device 200 in the foregoing example is only possible composition. In some other embodiments of this application, the electronic device 200 may alternatively include other composition. For example, to implement the wireless communication function of the electronic device 200, a communication module as shown in FIG. 4 may be arranged in the electronic device. The communication module may include an antenna, a radio frequency module that performs signal interaction with the antenna, and a processor that performs signal interaction with the radio frequency module. For example, the signal interaction between the radio frequency module and the antenna may be interaction of an analog signal. The signal interaction between the radio frequency module and the processor may be an analog signal or a digital signal. In some implementations, the processor may include a baseband processor.

In embodiments of this application, there may be a plurality of antennas arranged in the electronic device. The plurality of antennas may jointly constitute the antenna system provided in embodiments of this application.

For example, FIG. 5 shows schematic composition of an antenna system according to an embodiment of this application.

In this embodiment of this application, the antenna system may include at least one of a first antenna and a second antenna. For example, in the example the FIG. 5, the antenna system may include the first antenna and the second antenna. In some other embodiments, the antenna system may alternatively include the first antenna and at least one other type of antenna, or the antenna system may include the second antenna and at least one other type of antenna. The other types of antennas may include at least one of conventional antennas such as a monopole antenna, a dipole antenna, an IFA antenna, an ILA antenna, a LOOP antenna, and a left-handed antenna.

The following separately describes the first antenna and the second antenna in this example. In some scenarios, if the antenna system includes both the first antenna and the second antenna, operating frequency bands of the first antenna and the second antenna may at least partially overlap. For example, the operating frequency bands of the first antenna and the second antenna both include a first frequency band.

First, an example description of the first antenna is provided.

In some embodiments of this application, the first antenna may have the following structural features. The first antenna includes a first radiator. A length of the first radiator is less than one-half of a wavelength of the operating frequency band. For example, the length of the first radiator is less than one-half of a wavelength of the first frequency band. Two feed points are arranged on the first radiator The two feed points of the first radiator may be configured to access a feed signal provided by a common mode feed structure. In some embodiments, the two feed points of the first radiator may be arranged at two ends of the first radiator. In some embodiments, the two feed points of the first radiator may be referred to as a first feed point and a second feed point.

Through excitation of a common mode feed signal provided by the common mode feed structure, radiation may be excited to be performed on the first radiator in various modes including a fundamental mode. Operation in the fundamental mode is used as an example. The first radiator may include a current reversal point when the first antenna operates.

Composition of the common mode feed structure may vary in different implementations.

In some implementations of this example, the common mode feed structure may include two feeds. Ends of the two feeds with a same polarity (for example, positive poles or negative poles) may be respectively coupled to the two feed points of the first radiator. The two feeds in the common mode feed structure may be configured to feed equi-amplitude in-phase feed signals (namely, common mode feed signals) to the first radiator. Ends of the two feeds different from those coupled to the first radiator are separately grounded.

In some other implementations of this example, the common mode feed structure may include one feed. An end of the feed (for example, a positive end or a negative end) may be separately coupled to the two feed points of the first radiator, so that the feed inputs the common mode feed signals with equi-amplitude in-phase characteristics to the two feed points of the first radiator simultaneously. An end of the feed different from that coupled to the first radiator is grounded.

It should be noted that the feed signal inputted to the first radiator may be a feed signal in a low-impedance state. In this embodiment of this application, port characteristics of the feed signal may include a high-impedance state and a low-impedance state. The high-impedance state may be an impedance state in which port impedance is greater than 100 ohms. For example, the port impedance in the high-impedance state may be 200 ohms or 500 ohms. The low-impedance state may be an impedance state in which port impedance is less than 100 ohms. For example, the port impedance in the low-impedance state may be 50 ohms or 75 ohms.

In some embodiments, a matching circuit may be arranged between the common mode feed structure of the first antenna and the first radiator.

In some implementations, the matching circuit is configured to tune a port characteristic of the common mode feed signal to be in the low-impedance state.

It should be noted that in some implementations of this embodiment of this application, the high-impedance state or the low-impedance state may be a characteristic of a feed signal provided by the feed. For example, feed signals outputted by a feed 21 and a feed 22 in the common mode feed structure may have the port characteristic in the low-impedance state. In some other implementations, the high-impedance state or the low-impedance state may be obtained through tuning of a matching circuit between the feed and a radiator. For example, the feed 21 and the feed 22 in the common mode feed structure may output feed signals in the high-impedance state. In this case, a matching circuit arranged between the feed 21 and a radiator 11 and a matching circuit arranged between the feed 22 and the radiator 11 may be configured to tune the feed signals in the high-impedance state to feed signals in the low-impedance state, so that feed signals finally transmitted to the radiator 11 may have port impedance in the low-impedance state.

In some other implementations, the matching circuit may be further configured to tune port matching between the common mode feed signal and the first radiator, so that port impedance in an operating frequency band is as close as possible, thereby reducing energy reflection at a port.

In some other implementations, the matching circuit may be further configured to tune an operating frequency of the first antenna.

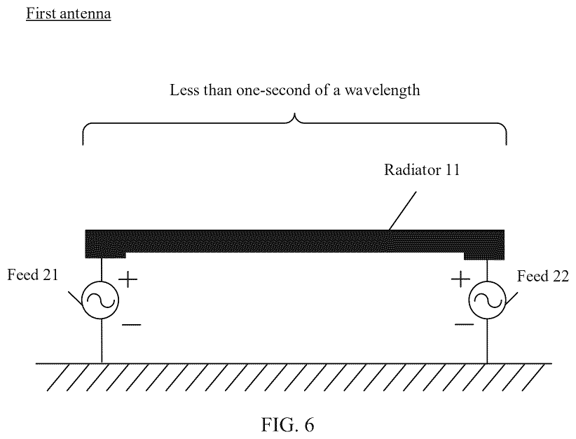

In an example, FIG. 6 is a diagram of a structure of a first antenna.

In the example as shown in FIG. 6, the first radiator may correspond to a radiator 11. The common mode feed structure may include a feed 21 and a feed 22. A positive pole of the feed 21 is coupled to an end of the radiator 11, and a positive pole of the feed 22 is coupled to the other end of the radiator 11.

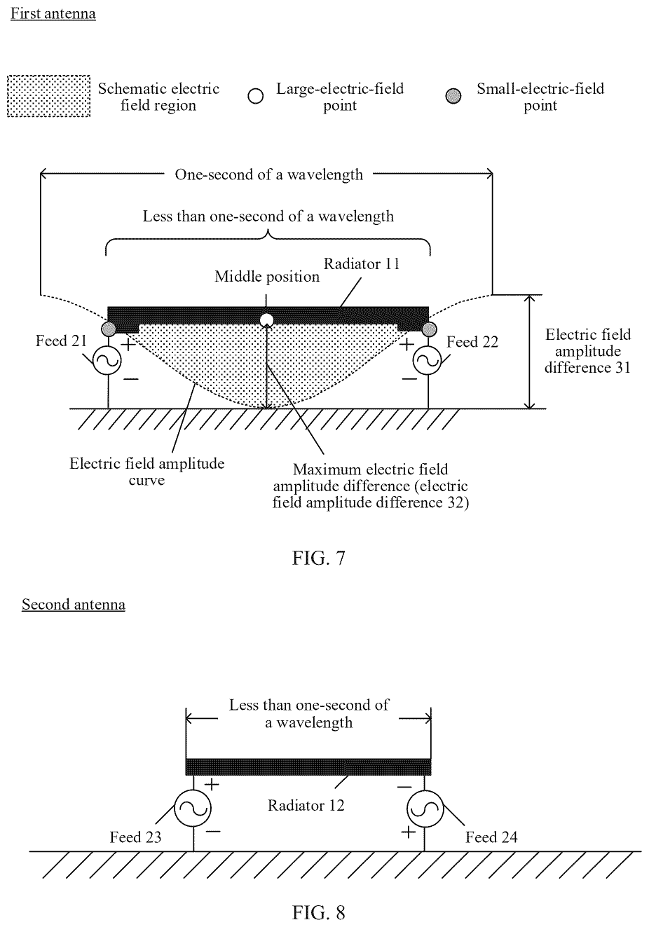

FIG. 7 shows schematic electric field distribution when the first antenna shown in FIG. 6 operates. For ease of description, FIG. 7 also shows an electric field distribution status after the first radiator (namely, the radiator 11) is extended to one-half of a wavelength of an operating frequency band.

When a length of the radiator 11 is one-half of the wavelength of the operating frequency band, a maximum electric field amplitude difference between the radiator 11 and a reference ground is an electric field amplitude difference 31 (which may also be referred to as a second value). When the length of the radiator 11 is less than one-half of the wavelength of the operating frequency band as shown in FIG. 6, the maximum electric field amplitude difference between the radiator 11 and the reference ground is an electric field amplitude difference 32 (which may also be referred to as a first value).

That the antenna shown in FIG. 7 operates in a fundamental mode is used as example. From a perspective of current distribution, a middle position of the radiator 11 may be considered as a point with a smallest current amplitude, and two ends of the radiator may be considered as points with a largest current amplitude. In other words, a small-current point in the middle position and large-current points respectively located at the two ends may be distributed on the radiator 11.

It is well known to a person skilled in the art that, during antenna resonance, an electric field amplitude is small in a nearby region corresponding to a large current, and an electric field amplitude is large in a nearby region corresponding to a small current. In this case, in a region between the radiator 11 and the reference ground, an electric field amplitude near the small-current point in the middle position on the radiator 11 is large, corresponding to a large-electric-field point between the middle position of the radiator 11 and the reference ground. Similarly, electric field amplitudes near the large-current points at the two ends of the radiator 11 are small, corresponding to small-electric-field points between the reference ground and positions of the two ends of the radiator 11.

The antenna radiator 11 shown in FIG. 7 is relatively short (for example, less than one-half of the wavelength of the first frequency band). Therefore, a decrease in the electric field amplitude near the large-electric-field point is less than the maximum electric field amplitude difference at the two ends. In a preferred embodiment, when the length of the radiator 11 is less than one-fourth of the wavelength of the first frequency band, a change in the large-electric-field-amplitude point in the middle of the radiator compared with that in the small-electric-field-amplitude points at the two ends is relatively small. In other words, a decrease in the maximum electric field amplitude difference to a particular extent can be considered as indicating approximately uniform electric field distribution.

From another perspective, in an operating state in the fundamental mode, regardless of the length of the radiator, in space between the radiator and the reference ground, electric field intensity distribution conforms to a characteristic that electric field intensity is larger in the middle and is smaller on two sides. In this case, in the example solution shown in FIG. 7, as the length of the radiator becomes less than one-half of the wavelength of the first frequency band, equivalently, the reference ground may move upward regarding the electric field distribution, and a point with a largest electric field amplitude moves toward the radiator (that is, the maximum electric field amplitude difference decreases).

In this way, when the first antenna shown in FIG. 7 operates, the maximum electric field amplitude difference (namely, the electric field amplitude difference 32) between the radiator 11 and the reference ground may be less than the maximum electric field amplitude difference (namely, the electric field amplitude difference 31) between the radiator and the reference ground when the length of the radiator is one-half of the wavelength of the first frequency band or greater.

It may be understood that, in a radiation process of the antenna, a larger electric field amplitude difference indicates a larger difference between corresponding electric field intensity at different positions in space around the radiator. In this case, radiation performance is relatively weak at a position with a relatively weak electric field intensity. Consequently, overall radiation performance of the antenna is relatively poor. In addition, when radiation power of the antenna is unchanged, energy is more concentrated toward the middle position with the larger electric field amplitude, causing a radiated hotspot of the antenna to be more significant and a SAR to deteriorate.

Correspondingly, a smaller electric field amplitude difference corresponds to a smaller difference between electric field intensity at different positions in the space around the radiator. In this case, radiation performance at a position with a relatively weak electric field does not significantly decrease compared with radiation performance at a position with a relatively strong electric field intensity. In this way, compared with a case in which the electric field amplitude difference is relatively large, the overall radiation performance of the antenna can be improved in this case. In addition, when the radiation power of the antenna is unchanged, a difference between the electric fields intensity at positions in the space is relatively small. Therefore, a radiated hotspot of the antenna is insignificant and a SAR is relatively low.

Therefore, as shown in FIG. 6 or FIG. 7, the antenna solution in which the radiator is less than one-half of the wavelength of the first frequency band and the common mode feed structure is arranged at the two ends can provide better radiation performance and a lower SAR due to a smaller maximum electric field amplitude difference.

With reference to the foregoing description as shown in FIG. 7, when the length of the radiator is smaller, an electric field amplitude curve moves more upward toward the radiator from the middle position, and two sides are symmetrically distributed. Therefore, in this scenario, an electric field amplitude difference between the middle position and positions of endpoints on the two sides is smaller. In this case, a smaller maximum electric field amplitude difference between nearby space of the large-electric-field point and nearby space of the small-electric-field point corresponds to a smaller electric field intensity distribution difference between various positions between the radiator and the reference ground. This is also more conducive to antenna radiation.

In some embodiments of the application, a length of the first radiator of the first antenna may be less than one-fourth of the wavelength of the operating frequency band. In this case, a difference between electric field intensity near the two ends of the radiator 11 (corresponding to the small-electric-field points) and electric field intensity near the middle position of the radiator 11 (corresponding to the large-electric-field point) is relatively small. It may be approximately considered that electric field intensity distribution between the radiator and the reference ground tends to be uniform. In this way, problems of poor radiation performance and a relatively high SAR that are significantly caused by an electric field intensity distribution difference between various positions can be better avoided. In some other embodiments of this application, a length of the first radiator of the first antenna may be less than one-eighth of the wavelength of the operating frequency band. Based on similar derivation, when the length of the first radiator is less than one-half of the wavelength of the operating frequency band, the first antenna may also have relatively good radiation performance and a relatively low SAR.

In the foregoing examples, an example in which the length of the first radiator is less than one-half of the wavelength of the operating frequency band is used for description. In some other embodiments of this application, the length of the first radiator may alternatively be equal to one-half of the wavelength of the operating frequency band. It may be understood that, a smaller length of the first radiator indicates a smaller corresponding maximum electric field amplitude difference and better radiation performance.

It should be noted that FIG. 6 and FIG. 7 show merely composition examples of the first antenna, and do not constitute a structural limitation on the first antenna. In some other embodiments, the first antenna may alternatively have other composition. It may be understood that an antenna with an antenna radiator whose length is less than or equal to one-half of the wavelength and an antenna that is fed by providing a common mode feed structure at two ends may be both included in a range of the first antenna.

In addition, the foregoing examples in FIG. 6 and FIG. 7 are both described by using an example in which the feed 21 and the feed 22 are arranged at the two ends of the radiator 11. In some other embodiments of this application, the feed 21 and/or the feed 22 may alternatively be arranged at a position other than the ends of the radiator 11. In other words, a part of the radiator 11 may be included between the feed 21 and the feed 22. A part of the radiator 11 may also be included on a side of the feed 21 away from the feed 22, and/or a side of the feed 22 away from the feed 21. With reference to the foregoing analysis in FIG. 7, in this case, a relatively low maximum electric field amplitude difference may be obtained in a region between the feed 21 and the feed 22, to improve radiation performance. In addition, a part of the radiator on the side of the feed 21 away from the feed 22, or a part of the radiator on the side of the feed 22 away from the feed 21 may operate in another mode or frequency band, so that a user further improves radiation performance in the operating frequency band, or enables the first antenna to obtain a multi-band coverage capability.

As described above in the example of FIG. 5, in some implementations of this application, the antenna system may further include a second antenna.

An example description of the second antenna is provided below.

In this application, the second antenna may have the following structural features. The second antenna includes a second radiator. A length of the second radiator is less than one-half of the wavelength of the operating frequency band (for example, the first frequency band). Two feed points are arranged on the second radiator. The two feed points of the second radiator may be configured to access a feed signal provided by a differential mode feed structure. In some embodiments, the two feed points of the second radiator may be arranged at two ends of the second radiator. In some embodiments, the two feed points on the second radiator may be referred to as a third feed point and a fourth feed point.

Through excitation of a differential mode feed signal provided by the differential mode feed structure, radiation may be excited to be performed on the second radiator in various modes including a fundamental mode. Operation in the fundamental mode is used as an example. When the second antenna operates, same-direction currents without a current reversal point are distributed on the second radiator for radiation.

In different implementations, composition of the differential mode feed structure may vary.

In some implementations of this example, the differential mode feed structure may include two feeds. Ends of the two feeds with different polarities may be respectively coupled to the two feed points of the second radiator. For example, a positive pole of one feed is coupled to one feed point of the second radiator, and a negative pole of the other feed is coupled to the other feed point of the second radiator.

The two feeds in the differential mode feed structure may be configured to feed equi-amplitude phase-inverted feed signals (namely, differential mode feed signals) to the second radiator. Ends of the two feeds different from those coupled to the second radiator are separately grounded.

In some other implementations of this example, the differential mode feed structure may include one feed. One end of the feed (for example, a positive end or a negative end) may be coupled to one feed point of the second radiator. The other end of the feed may be coupled to the other feed point of the second radiator through an inverting device. The inverting device may have a 180-degree phase inversion modulation function. An end of the feed different from those coupled to the second radiator is grounded.

It should be noted that the feed signal inputted to the second radiator may be a feed signal in a high-impedance state. For example, a port impedance in the high-impedance state may be 200 ohms or 500 ohms.

In some embodiments, a matching circuit may be further arranged between the differential mode feed structure of the second antenna and the second radiator.

In some implementations, the matching circuit is configured to tune a port characteristic of the differential mode feed signal to be in the high-impedance state.

With reference to the foregoing example of obtaining the port characteristic in the low-impedance state, in some implementations of embodiments of this application, the high-impedance state may be a characteristic of a feed signal provided by the feed. For example, feed signals outputted by a feed 23 and a feed 24 in the differential mode feed structure may have the port characteristic in the high-impedance state. In some other implementations, the high-impedance state may be obtained through tuning performed by the matching circuit between the feed and the radiator. For example, the feed 23 and the feed 24 in the differential mode feed structure may output feed signals in the low-impedance state. In this case, a matching circuit arranged between the feed 23 and a radiator 12 and a matching circuit arranged between the feed 24 and the radiator 12 may be configured to tune the feed signals in the low-impedance state to feed signals in the high-impedance state, so that feed signals finally transmitted to the radiator 12 may have port impedance in the high-impedance state.

In some other implementations, the matching circuit may be further configured to tune port matching between the differential mode feed signal and the second radiator, so that port impedance in an operating frequency band is as close as possible, thereby reducing energy reflection at a port.

In some other implementations, the matching circuit may be further configured to tune an operating frequency of the second antenna.

In an example, FIG. 8 is a diagram of a structure of a second antenna.

In the example as shown in FIG. 8, the second radiator may correspond to a radiator 12. The differential mode feed structure may include a feed 23 and a feed 24. A positive pole of the feed 23 is coupled to an end of the radiator 12, and a negative pole of the feed 24 is coupled to the other end of the radiator 12.

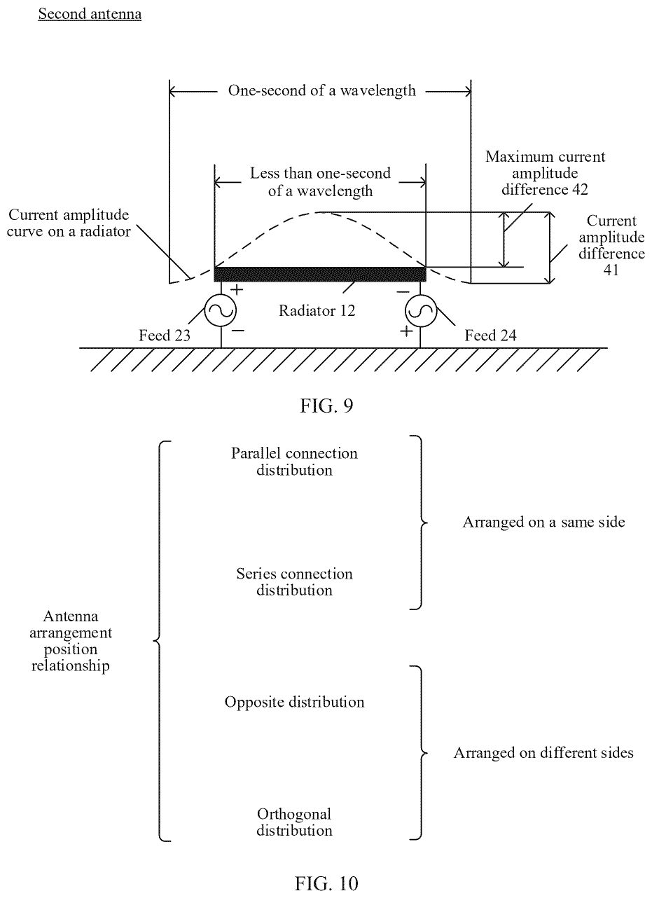

FIG. 9 shows schematic current intensity distribution on the radiator 12 when the second antenna shown in FIG. 8 operates. For case of description, FIG. 9 also shows schematic current intensity distribution after the second radiator (namely, the radiator 12) is extended to one-half of a wavelength of an operating frequency band.

It may be understood that the feed signal may be usually a sine signal. In this case, current intensity at different positions on the radiator may be different at a same moment. In the example of FIG. 9, when a length of the radiator 12 is one-half of the wavelength of the operating frequency band, a maximum current amplitude difference on the radiator is denoted as a current amplitude difference 41 (which may also be referred to as a fourth value). Correspondingly, when the length of the radiator 12 is provided to be less than one-half of the wavelength of the operating frequency band according to the example in FIG. 8, the maximum current amplitude difference on the radiator is denoted as a current amplitude difference 42 (which may also be referred to as a third value).

It should be understood that in an operating state of the fundamental mode, regardless of the length of the radiator, current intensity distribution conforms to a characteristic that current intensity is larger in the middle and is smaller on two sides. In this case, comparing a case in which the length of the second radiator is one-half of the wavelength of the operating frequency band with a case in which the length of the second radiator is less than one-half of the wavelength, as the length of the radiator is less than one-half of the wavelength of the operating frequency band, a corresponding schematic current amplitude curve moves downward based on a current intensity distribution curve obtained when the length is one-half of the wavelength of the operating frequency band. Therefore, in the example of FIG. 9, when the length of the second radiator is less than one-half of the wavelength of the operating frequency band, the maximum current amplitude difference distributed on the radiator is reduced. In addition, as an amplitude difference between current intensity on the radiator becomes smaller, energy distribution in space near the radiator tends to be more decentralized. In this way, radiation performance of the antenna can be effectively improved.

In some embodiments of this application, the length of the second radiator may be further reduced, for example, set to be less than or equal to one-fourth of an operating wavelength. Alternatively, the length of the second radiator is set to be less than or equal to one-eighth of an operating wavelength. In this way, the maximum current amplitude difference on the second radiator can be better controlled. When the maximum current amplitude difference on the second radiator is less than a preset threshold, it may be approximately considered that currents on the second radiator tend to be uniform. In addition, when currents on the radiator tend to be uniform, energy distribution in space near the radiator (for example, between the radiator and a reference ground) is more uniform, so that a relatively large loss caused by energy concentration does not occur. In this way, radiation performance of the second antenna can be significantly improved when the length of the radiator is less than or equal to one-half of the wavelength.

In the foregoing examples, an example in which the length of the second radiator is less than one-half of the wavelength of the operating frequency band is used for description. In some other embodiments of this application, the length of the second radiator may altematively be equal to one-half of the wavelength of the operating frequency band. It may be understood that, a smaller length of the second radiator indicates a smaller corresponding maximum current amplitude difference and better radiation performance.

It should be noted that FIG. 8 and FIG. 9 are merely composition examples of the second antenna, and do not constitute a structural limitation on the second antenna. In some other embodiments, the second antenna may alternatively include other composition. It may be understood that an antenna with an antenna radiator whose length is less than or equal to one-half of the wavelength and an antenna that is fed by providing a differential mode feed structure at two ends may be both included in a range of the second antenna.

In addition, the foregoing examples in FIG. 8 and FIG. 9 are both described by using an example in which the feed 23 and the feed 24 are arranged at the two ends of the radiator 12. In some other embodiments of this application, the feed 23 and/or the feed 24 may alternatively be arranged at a position other than the ends of the radiator 12. In other words, a part of the radiator 12 may be included between the feed 23 and the feed 24. A part of the radiator 12 may also be included on a side of the feed 23 away from the feed 24, and/or a side of the feed 24 away from the feed 23. With reference to the foregoing analysis in FIG. 9, in this case, a relatively low maximum current amplitude difference may be obtained on the radiator between the feed 23 and the feed 24, to improve radiation performance. In addition, a part of the radiator on the side of the feed 23 away from the feed 24, or a part of the radiator on the side of the feed 24 away from the feed 23 may operate in another mode or frequency band, so that a user further improves radiation performance in the operating frequency band, or enables the first antenna to obtain a multi-band coverage capability.

In the foregoing embodiments, through descriptions of FIG. 6 to FIG. 9, composition of the first antenna and composition of the second antenna in this application are described by using an example.

The first antenna and/or the second antenna may be arranged in the electronic device, so that a relatively good wireless communication capability of the electronic device can be realized through relatively good radiation performance provided by the first antenna and/or the second antenna. In the following description, an example is used in which an antenna system in an electronic device includes a first antenna and a second antenna, and operating frequency bands of the first antenna and the second antenna include a first frequency band obtained when the operating frequency bands at least partially overlap. In this way, the first antenna and the second antenna may jointly provide a coverage capability of the operating frequency band (for example, the first frequency band), so that the antenna system can provide better radiation performance in the operating frequency band. In some embodiments, the first antenna may have the composition shown in FIG. 6. Alternatively, the length of the radiator of the first antenna may be equal to one-half of a wavelength of the operating frequency band. In some other embodiments, the second antenna may have the composition shown in FIG. 8. Alternatively, the length of the radiator of the second antenna may be equal to one-half of the wavelength of the operating frequency band.

It should be noted that in this embodiment of this application, an arrangement of the first antenna and the second antenna on the electronic device may alternatively be performed with reference to reference ground eigenmode distribution provided by the electronic device.

It may be understood that the reference ground eigenmode distribution may include current eigenmode distribution and electric field eigenmode distribution.

The electric field eigenmode distribution is used as an example. The electric field eigenmode distribution may vary at different frequencies. Correspondingly, the first antenna may be arranged at a position at which a reference ground electric field eigenmode is relatively large. In this way, the first antenna can better radiate by exciting the reference ground by using an electric field with a relatively small maximum electric field amplitude difference between the first radiator and the reference ground, thereby obtaining better radiation performance.

The current eigenmode distribution is used as an example. The current eigenmode distribution may vary at different frequencies. Correspondingly, the second antenna may be arranged at a position at which a reference ground current eigenmode is relatively large. When the second antenna operates, the maximum current amplitude difference on the second radiator is relatively small, and a corresponding maximum magnetic field amplitude difference between the second radiator and the reference ground is also relatively small. Therefore, when the second antenna is arranged at the position at which the reference ground current eigenmode is relatively large, radiation can be better performed by exciting the reference ground through a magnetic field, so that better radiation performance is obtained.

When the antenna system includes both the first antenna and the second antenna, arrangements of the first antenna and the second antenna may alternatively be performed with reference to the foregoing reference ground eigenmode distribution.

In different implementations of embodiments of this application, there may be a plurality of possibilities for a relative position relationship between the first antenna and the second antenna on the electronic device. In different implementations, the first antenna and the second antenna may both have relatively good isolation. In this way, when the operating frequency bands of the first antenna and the second antenna at least partially overlap, the first antenna and the second antenna can also operate without affecting each other.

Positions of the first antenna and the second antenna on the electronic device are described below by way of example with reference to the accompanying drawings.

For example, refer to FIG. 10. In a division manner, division may be performed based on the relative position relationship between the first antenna and the second antenna, and there may be parallel connection distribution, series connection distribution, opposite distribution, and orthogonal distribution through the division.

In another division manner, division is performed based on a relationship among the first antenna, the second antenna, and an edge of the electronic device when the first antenna and the second antenna are arranged on the electronic device, and the relative position relationship between the first antenna and the second antenna may be divided into “arranged on a same edge”, and “arranged on different edges”.

In still another division manner, division is performed based on a relationship of whether the first antenna and the second antenna share the entire radiator or a part of the radiator, and the relative position relationship between the first antenna and the second antenna may be divided into “joint arrangement” and “non-joint arrangement”. “Joint arrangement” means that the first antenna and the second antenna share a same radiator for radiation. “Non-joint arrangement” means that the first antenna and the second antenna use different radiators for radiation.

The foregoing three division manners are also connected to each other.

“Arranged on a same edge” may include the parallel connection distribution and the series connection distribution, and “arranged on different edges” may include the opposite distribution and the orthogonal distribution.

The parallel connection distribution may be achieved through “jointly arranged” and “non-jointly arranged”. The series connection distribution, the opposite distribution, and the orthogonal distribution may be achieved through “non-jointly arranged”.

In some embodiments, that the first antenna and the second antenna are distributed in series connection is used as an example.

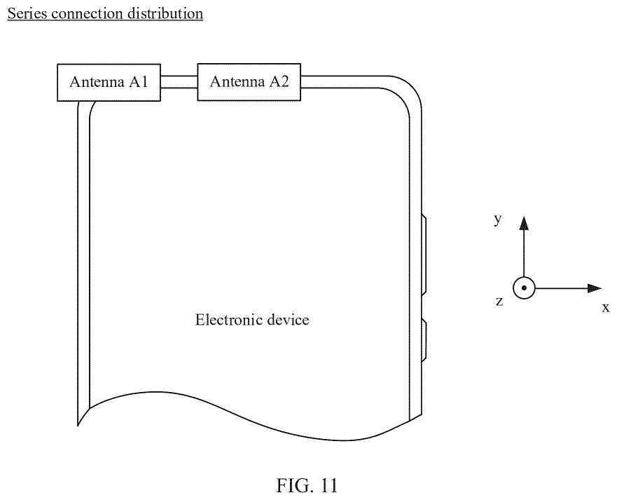

Refer to FIG. 11. The first antenna may correspond to an antenna A1 as shown in FIG. 11, and the second antenna may correspond to an antenna A2 as shown in FIG. 11. In a series connection distribution scenario, the antenna A1 and the antenna A2 may be separately located on a same edge of an electronic device. In addition, the antenna A1 and the antenna A2 that are distributed in series connection may be located at different positions on the same edge. In other words, projection of the antenna A1 and projection of the antenna A2 in a direction to a perpendicular line at a center of the electronic device do not overlap each other. In an example as shown in FIG. 11, the antenna A1 and the antenna A2 may be distributed on a top edge of the electronic device. In addition, the antenna A1 and the antenna A2 are arranged on a same approximately straight line. This is similar to stringing one after the other on the straight line. Therefore, similar distribution of the antenna A1 and the antenna A2 is referred to as series connection distribution in the present invention. In this way, the antenna A1 and the antenna A2 are located at different positions on the top edge on an X axis. In some other examples, the antenna A1 and the antenna A2 that are distributed in series connection may alternatively be located together on a side edge of the electronic device. In this way, the antenna A1 and the antenna A2 are located at different positions on the side edge on a Y axis. Alternatively, the antenna A1 and the antenna A2 that are distributed in series connection may be located together on a bottom edge of the electronic device. In this way, the antenna A1 and the antenna A2 are located at different positions on the bottom edge on the X axis.

It should be noted that in another possible implementation in the series connection distribution scenario of FIG. 11, antenna forms of the antenna A1 and the antenna A2 may alternatively be the same. For example, the antenna A1 and the antenna A2 may both be first antennas. Alternatively, the antenna A1 and the antenna A2 may both be second antennas.

In some other embodiments, that the first antenna and the second antenna are distributed in parallel connection is used as an example.

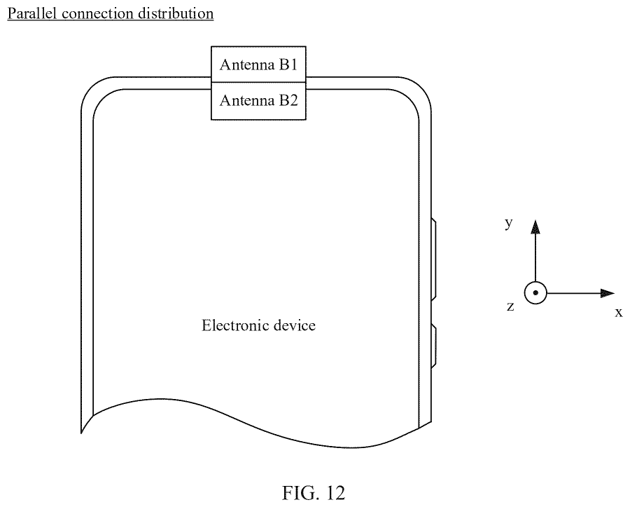

Refer to FIG. 12. The first antenna may correspond to an antenna B1 as shown in FIG. 12, and the second antenna may correspond to an antenna B2 as shown in FIG. 12. The antenna B1 and the antenna B2 may be separately located on a same edge, for example, a top edge, of the electronic device. In addition, projection of the antenna B1 and projection of the antenna B2 on the same edge, for example, the top edge, partially or completely overlap. Therefore, distribution of the antenna B1 and the antenna B2 is referred to as the parallel connection distribution in the present invention. In an example as shown in FIG. 12, the antenna B1 and the antenna B2 may be distributed in parallel connection on the top edge of the electronic device. Projection of the antenna B1 and projection of the antenna B2 in a direction to a perpendicular line at a center of the electronic device (that is, a negative Y-axis direction) may partially or completely overlap. In some other examples, the antenna B1 and the antenna B2 that are distributed in parallel connection may alternatively be located together on a side edge of the electronic device. Projection of the antenna B1 and projection of the antenna B2 in a direction to a perpendicular line at a center of the electronic device (that is, a positive or negative X-axis direction) may partially or completely overlap. In some other examples, the antenna B1 and the antenna B2 that are distributed in parallel connection may alternatively be located together on a bottom edge of the electronic device. Projection of the antenna B1 and projection of the antenna B2 in a direction to a perpendicular line at a center of the electronic device (that is, a positive Y-axis direction) may partially or completely overlap.

It should be noted that in the parallel connection distribution as shown in FIG. 12, a position relationship between the antenna B1 and the antenna B2 is logically shown. The position relationship as shown in FIG. 12 does not constitute a limitation on a spatial structure of the antenna B1 and the antenna B2.

In some embodiments, the antenna B1 and the antenna B2 may separately radiate by using different radiators, that is, the antenna B1 and the antenna B2 are non-jointly arranged. In some other embodiments, radiators of the antenna B1 and the antenna B2 may at least partially overlap, that is, the antenna B1 and the antenna B2 are jointly arranged. For example, the antenna B1 and the antenna B2 may reuse, as a radiator of the two antennas, a section of metal bezel with a length that is less than one-half of the wavelength of the operating frequency band on the top edge of the electronic device. A common mode feed structure corresponding to the antenna B1 and a differential mode feed structure corresponding to the antenna B2 may be respectively connected to two ends of the radiator, so that at a same moment, the first antenna and the second antenna can be excited, on the metal bezel, to radiate in different corresponding modes.

It should be noted that in another possible implementation in the parallel connection distribution scenario of FIG. 12, antenna forms of the antenna B1 and the antenna B2 may alternatively be the same. For example, the antenna B1 and the antenna B2 may both be first antennas. Alternatively, the antenna B1 and the antenna B2 may both be second antennas.

In some other embodiments, that the first antenna and the second antenna are oppositely distributed is used as an example.

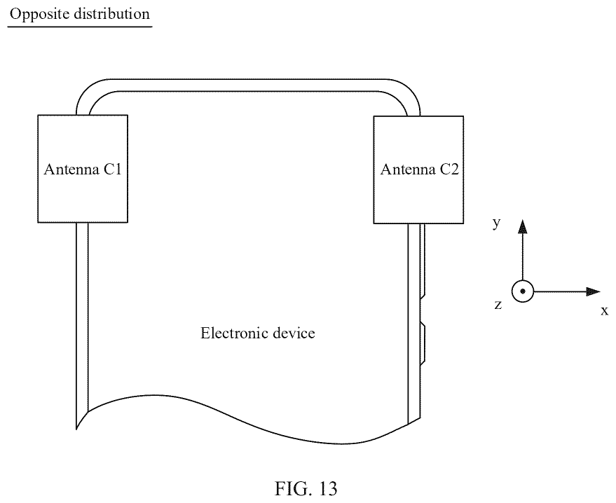

Refer to FIG. 13. The first antenna may correspond to an antenna C1 as shown in FIG. 13, and the second antenna may correspond to an antenna C2 as shown in FIG. 13. The antenna C1 and the antenna C2 are respectively located on two opposite edges of an electronic device. Distribution of the antenna C1 and the antenna C2 is referred to as opposite distribution in the present invention. In some implementations, projection of the antenna C1 and projection of the antenna C2 on any one of the two opposite edges at least partially overlap. In a preferred embodiment, projection of the antenna C1 and projection of the antenna C2 on any one of the two opposite edges completely overlap. In other words, the antenna C1 and the antenna C2 are completely oppositely distributed on the two opposite edges of the electronic device. In an example as shown in FIG. 13, the antenna C1 and the antenna C2 may be oppositely distributed on a left edge and a right edge of the electronic device. Projection of the antenna C1 and projection of the antenna C2 along an X-axis direction may at least partially overlap. In some other examples, the antenna C1 and the antenna C2 that are oppositely distributed may alternatively be respectively located on a top edge or a bottom edge of the electronic device. Projection of the antenna C1 and projection of the antenna C2 along a Y-axis direction may at least partially overlap.

It should be noted that in another possible implementation in the opposite distribution scenario as shown in FIG. 13, antenna forms of the antenna C1 and the antenna C2 may alternatively be the same. For example, the antenna C1 and the antenna C2 may both be first antennas. Alternatively, the antenna C1 and the antenna C2 may both be second antennas.

In some other embodiments, that the first antenna and the second antenna are orthogonally distributed is used as an example.

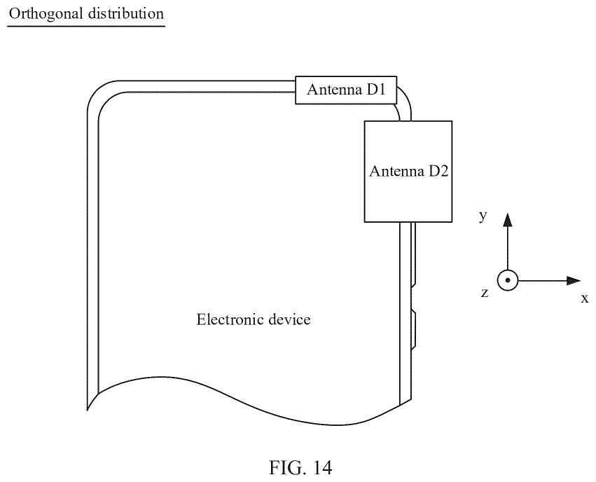

Refer to FIG. 14. The first antenna may correspond to an antenna D1 as shown in FIG. 14, and the second antenna may correspond to an antenna D2 as shown in FIG. 14. The antenna D1 and the antenna D2 are respectively located on two adjacent edges of an electronic device. Distribution of the antenna D1 and the antenna D2 is referred to as orthogonal distribution in the present invention. With reference to FIG. 14, the antenna D1 may be located on a top edge of the electronic device, and the antenna D2 may be correspondingly located on a side edge of the electronic device. In some other examples, the antenna D1 may be located on a side edge of the electronic device, and the antenna D2 may be correspondingly located on the top edge or a bottom edge of the electronic device. In some other embodiments, the antenna D1 may be located on the bottom edge of the electronic device, and the antenna D2 may be correspondingly located on a side edge of the electronic device.

It should be noted that in another possible implementation in the orthogonal distribution scenario as shown in FIG. 14, antenna forms of the antenna D1 and the antenna D2 may alternatively be the same. For example, the antenna D1 and the antenna D2 may both be first antennas. Alternatively, the antenna D1 and the antenna D2 may both be second antennas.

It may be understood that the relative position relationship descriptions in FIG. 11 to FIG. 14 may alternatively be described as a difference between parallel and orthogonality. For example, in the series connection distribution shown in FIG. 11, the parallel connection distribution shown in FIG. 12, and the opposite distribution shown in FIG. 13, edges of the electronic device on which the two antennas are located are a same edge or two edges that are parallel to each other. Therefore, in this embodiment of this application, the series connection distribution, the parallel connection distribution, and the opposite distribution may alternatively be referred to as parallel distribution. Correspondingly, as shown in the orthogonal distribution shown in FIG. 14, the two adjacent edges of the electronic device on which the two antennas are located may be non-parallel, for example, perpendicular or nearly perpendicular, to each other.

In this embodiment of this application, the first antenna and the second antenna may both have relatively good isolation when the first antenna and the second antenna have the relative positional arrangement provided in any one of FIG. 11 to FIG. 14.

The following uses the relative position relationships, namely, series connection and parallel connection, as provided in FIG. 11 and FIG. 12 as an example to describe obtaining a high isolation effect. In the opposite distribution and orthogonal distribution scenarios shown in FIG. 13 and FIG. 14, for obtaining a high isolation effect, refer to FIG. 11 and FIG. 12. Details are not described again.

It should be noted that when the antenna radiates, the radiation is not performed by relying on only an antenna radiator. With reference to the foregoing descriptions of the arrangements of the first antenna and the second antenna and the reference ground eigenmode distribution, in some cases, the radiation of the antenna may include radiation of the antenna radiator and radiation of the antenna exciting a floor.

In this case, to obtain relatively good isolation between the two antennas, it is required that mode distribution characteristics on antenna radiators are different, and characteristic distribution obtained when the antennas radiate by exciting the floor is also different.

For example, that the mode distribution characteristics on the antenna radiators are different includes: When the antennas operate, distribution of currents excited on the radiators is different (for example, a quantity and/or positions of current reversal points on the radiators is/are different). For another example, that the characteristic distribution obtained when the antennas radiate by exciting the floor is also different includes: When the antennas operate, distribution of respective corresponding currents on the reference ground is different (for example, currents excited on the reference ground are oppositely orthogonal or close to be orthogonal).

With reference to the descriptions of the first antenna and the second antenna in FIG. 6 to FIG. 9, that the two antennas both operate in the fundamental mode is used as an example. In this case, one current reversal point may be distributed on the first antenna, and there may be no current reversal point on the second antenna. In this way, current distribution of the first antenna and the second antenna in the operating frequency band is also different.

In addition, in different relative positional arrangement cases, distribution of currents excited by the first antenna and the second antenna on a reference ground is also different.

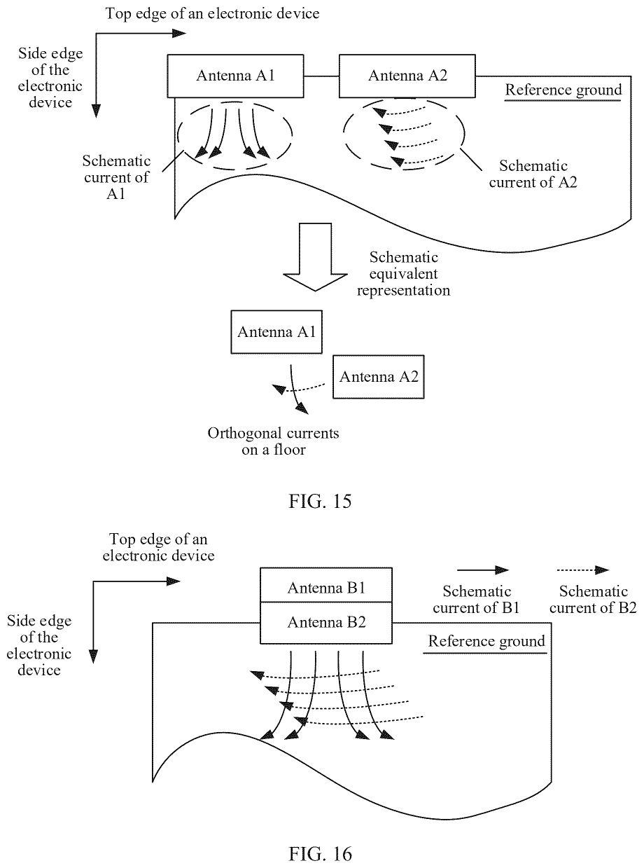

For example, refer to FIG. 15. That a first antenna (for example, an antenna A1) and a second antenna (for example, an antenna A2) are distributed in series connection on a top edge of an electronic device is used as an example.

When the antenna A1 operates, a direction of a current excited on a floor is shown as that of a schematic current of A1.

A current along a direction of a long edge of the electronic device may be distributed on a floor near a middle position of the antenna A1, that is, corresponding to a longitudinal current as shown in FIG. 15.

When the antenna A2 operates, a direction of a current excited on a floor is shown as that of a schematic current of A2.

Similar to the schematic current of A1, a current along a direction of a short edge of the electronic device may be distributed on a floor near a middle position of the antenna A2, that is, corresponding to a transverse current as shown in FIG. 15.

In this case, at an intersection of the currents excited by the antenna A1 and the antenna A2 on the floors, the current excited by the antenna A1 and the current excited by the antenna A2 may show an effect close to orthogonal current distribution.

Therefore, in the series connection distribution case as shown in FIG. 11 or FIG. 15, distribution of currents excited by the antenna A1 and the antenna A2 on a reference ground is also different.

In addition, current distribution on radiators of the antenna A1 and the antenna A2 is also different. Therefore, relatively good isolation can be obtained when the antenna A1 and the antenna A2 are distributed in series connection. In this way, when operating frequency bands of the antenna A1 and the antenna A2 at least partially overlap, the antenna A1 and the antenna A2 may both further provide relatively good radiation performance in the operating frequency bands thereof.

It may be understood that FIG. 15 is described by using an example in which the first antenna and the second antenna are different forms of antennas and are distributed in series connection. In some other embodiments of this application, that the antenna A1 and the antenna A2 are both first antennas is used as an example. In this case, for a current on a floor, due to a difference between positions of the antenna A1 and the antenna A2, an oblique current is distributed on the floor. For example, the antenna A1 may excite a current in a downward right direction on the floor. The antenna A2 may excite a current in a downward left direction on the floor. In this case, the currents excited by the two antennas on the floor may also be in an orthogonal state. In addition, antenna forms of the antenna A1 and the antenna A2 are the same, and current distributions on the radiators thereof are similar. However, positions of the antenna A1 and the antenna A2 are different. As shown in FIG. 15, the antenna A1 is located on a left side of a top edge, and the antenna A2 is located in the middle of the top edge. Therefore, from a perspective of a far field, there is also a specific difference between field distribution generated by the radiators of the antenna A1 and the antenna A2 in space. In this case, the antenna A1 and the antenna A2 may also have relatively good isolation in the operating frequency band.

It may be understood that, based on a cause similar to that of FIG. 15, in another parallel arrangement case, for example, in opposite distribution, the first antenna and the second antenna can also excite currents on a floor to be in orthogonal distribution, thereby achieving high isolation between the two antennas.

However, for the orthogonal distribution shown in FIG. 14, that the antenna D1 and the antenna D2 are both first antennas or second antennas is used as an example. In this case, the radiators of the two antennas are perpendicular to each other. Therefore, currents on the radiators are distributed to be perpendicular to each other. Correspondingly, the currents on the floor excited by the antennas may also have an orthogonal characteristic. For example, when the antenna D1 and the antenna D2 are both first antennas, the antenna D1 may excite a longitudinal current on the floor, and the antenna D2 may excite a transverse current that is on the floor and that is perpendicular to the radiator of the antenna D2. In this case, the transverse current and the longitudinal current may form an orthogonal state. In this way, the antenna D1 and the antenna D2 can have relatively good isolation.

In addition, that the antenna D1 and the antenna D2 have different antenna forms is used as an example. For example, the antenna D1 is a first antenna, and the antenna D2 is a second antenna. In this case, radiators of the first antenna and the second antenna are arranged orthogonally and close to each other. Therefore, directions of currents, perpendicular to the radiators, on a reference ground close to the radiators account for a main part. In this case, a longitudinal current excited by a first radiator and a transverse current excited by a second radiator can present an orthogonal state on a floor. In this way, the first antenna and the second antenna can obtain a high isolation characteristic during operation.

In the foregoing examples, cases in which the two antennas are distributed in series connection, opposite distribution, and orthogonal distribution are described with reference to FIG. 15. The following describes, with reference to FIG. 16, a case in which two antennas are distributed in parallel connection.

Refer to FIG. 16. That a first antenna (for example, an antenna B1) and a second antenna (for example, an antenna B2) are distributed in parallel connection on a top edge of an electronic device is used as an example. In an example as shown in FIG. 16, the antenna B1 and the antenna B2 may be distributed in parallel connection at a middle position of the top edge of the electronic device.

When the antenna B1 operates, a direction of a current excited on a floor is shown as that of a schematic current of B1.

The antenna B1 is an electric field type antenna that mainly radiates through an electric field, and therefore may excite a current perpendicular to a direction of a radiator of the antenna B1 on a reference ground. In other words, the antenna B1 may excite a longitudinal current along a direction of a side edge of the electronic device on the reference ground.

When the antenna B2 operates, a direction of a current excited on a floor is shown as that of a schematic current of B2.

The antenna B2 is a magnetic field type antenna that mainly radiates through a magnetic field, and therefore may excite a current along the direction of the radiator of the antenna B2 on the reference ground. In other words, the antenna B2 may excite a transverse current along a direction of the top edge of the electronic device on the reference ground.

The transverse current and the longitudinal current are orthogonal to each other. Therefore, distribution of currents excited by the antenna B1 and the antenna B2 on the reference ground is different.

In addition, distribution of currents on radiators of the antenna B1 and the antenna B2 is also different. Therefore, relatively good isolation can be obtained when the antenna B1 and the antenna B2 are distributed in parallel connection. In this way, when operating frequency bands of the antenna B1 and the antenna B2 at least partially overlap, the antenna B1 and the antenna B2 can both further provide relatively good radiation performance in the operating frequency bands thereof.

With reference to the foregoing description of the parallel connection distribution in FIG. 12, in a specific implementation of the parallel connection distribution, the first antenna and the second antenna may be jointly arranged or non-jointly arranged.

That the parallel connection distribution of the first antenna and the second antenna is implemented through “joint arrangement” is used as an example, and an example description is provided for arranging the first antenna and the second antenna.

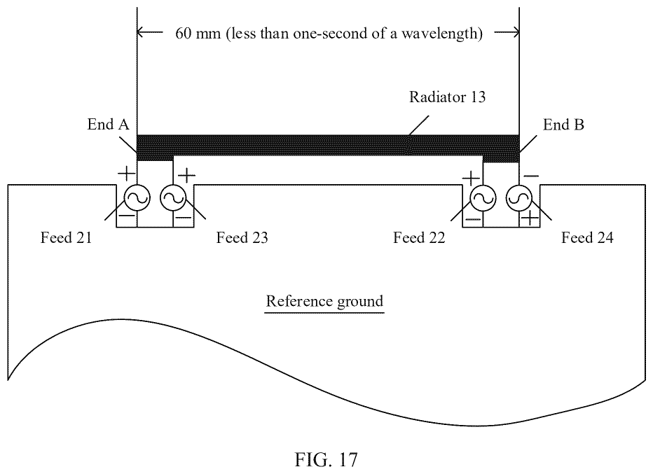

FIG. 17 shows schematic composition of an antenna system according to an embodiment of this application.

As shown in FIG. 17, the antenna system may include a first antenna and a second antenna that share a radiator 13. In some embodiments, the first antenna obtained through logical division of the antenna system shown in FIG. 17 may have the composition shown in FIG. 6. In some other embodiments, the second antenna obtained through logical division of the antenna system shown in FIG. 17 may have the composition shown in FIG. 8.

In this example, a feed 21 and a feed 23 may be coupled to one end of the radiator 13 (for example, an end A). Ends of the feed 21 and the feed 23 with a same polarity may be connected to the end A. The other ends of the feed 21 and the feed 23 may be separately ground. In some examples, the first antenna and the second antenna share the same radiator 13. The radiator 13 may also be referred to as a third radiator. Two ends of the third radiator may be respectively a first end and a second end.

For example, a positive pole of the feed 21 may be coupled to the end A, and a negative pole of the feed 21 may be grounded. Similarly, a positive pole of the feed 23 may be coupled to the end A, and a negative pole of the feed 23 may be grounded.

A feed 22 and a feed 24 may be coupled to the other end of the radiator 13 (for example, an end B). Ends of the feed 22 and the feed 24 with different polarities may be connected to the end B. The other ends of the feed 22 and the feed 24 may be separately ground.

For example, a positive pole of the feed 22 may be coupled to the end B, and a negative pole of the feed 22 may be grounded. Similarly, a negative pole of the feed 24 may be coupled to the end B, and a positive pole of the feed 24 may be grounded.

In another embodiment, the feed 21 and the feed 23 may alternatively be arranged at positions other than the ends of the radiator 13. The feed 22 and the feed 24 may alternatively be arranged at positions other than the ends of the radiator 13. In other words, a part of the radiator 13 may be included between the feeds 21/23 and the feeds 22/24 instead of the entire radiator 13. A part of the radiator 13 may also be included on a side of the feed 21/23 away from the feed 22/24 and/or a side of the feed 22/24 away from the feed 21/23. With reference to the foregoing analysis, in this case, a relatively low maximum current amplitude difference may be obtained on the radiator between the feed 23 and the feed 24, thereby improving radiation performance. In addition, a part of the radiator on the side of the feed 23 away from the feed 24, or a part of the radiator on the side of the feed 24 away from the feed 23 may operate in another mode or frequency band, so that a user further improves radiation performance in the operating frequency band, or enables the first antenna to obtain a multi-band coverage capability.

It may be understood that, with reference to the foregoing example of the common mode feed structure, in the feeding arrangement as shown in FIG. 17, the feed 21 and the feed 22 may constitute the common mode feed structure. In some embodiments, feed signals that are provided by the feed 21 and the feed 22 and that are inputted into the radiator 13 may be feed signals in a low-impedance state. The feed signal in the low-impedance state may be obtained through tuning by a matching circuit (not shown in FIG. 17) between the feed 21 and the radiator 13 and between the feed 22 and the radiator 13, or the feed signal in the low-impedance state may be directly provided by the feed 21 and the feed 22 as low-impedance feeds.

With reference to the foregoing example of the differential mode feed structure, in the feeding arrangement shown in FIG. 17, the feed 23 and the feed 24 may constitute the differential mode feed structure. In some embodiments, feed signals that are provided by the feed 23 and the feed 24 and that are inputted into the radiator 13 may be feed signals in a high-impedance state. The feed signal in the high-impedance state may be obtained through tuning by a matching circuit (not shown in FIG. 17) between the feed 23 and the radiator 13 and between the feed 24 and the radiator 13, or the feed signal in the high-impedance state may be directly provided by the feed 23 and the feed 24 as high-impedance feeds. For details, refer to the foregoing descriptions of the first antenna or the second antenna part.

In this way, when the antenna system shown in FIG. 17 operates, radiation of the first antenna and radiation of the second antenna can be simultaneously excited on the radiator 13 by using the common mode feed structure and the differential mode feed point structure. With reference to the description of FIG. 16, the radiation of the first antenna and the radiation of the second antenna have different current distribution on the radiator, and distribution of currents excited on a reference ground is also different. Therefore, the radiation of the first antenna and the radiation of the second antenna can be have relatively high isolation, thereby achieving an effect of not interfering with each other.

With reference to a structure shown in FIG. 17, simulation is performed thereon below. Radiation performance of the antenna system is proved through a simulation result.

In this example, that an operating frequency band is higher than 700 MHz (for example, 1 GHz), a dielectric constant (Dielectric constant, DK) corresponding to an antenna material is 3.2, and a dielectric dissipation factor (Dissipation factor, DF) corresponding to the antenna material is 0.01 is used as an example. For an antenna arranged based on the foregoing material, a dimension of one-half of a wavelength corresponding to the operating frequency band (for example, 1 GHz) may be close to 100 mm. That lengths of radiators of the first antenna and the second antenna are both less than one-half of the wavelength of the operating frequency band is used as an example. In this case, the length of the radiator 13 may be less than 100 mm. For example, in the following simulation, that the length of the radiator 13 is close to one-fourth of the wavelength (for example, 60 mm) of the operating frequency band is used as an example.

In a preferred embodiment, the length of the radiator 13 may be further reduced. For example, the length of the radiator 13 is set to be less than or equal to one-eighth of an operating wavelength. A smaller specified length of the radiator 13 indicates a more uniform electric field formed by the radiator 13 between the radiator 13 and the reference ground in the common mode feed structure, and indicates better radiation performance in this mode. A smaller specified length of the radiator 13 indicates more uniform currents that flow on the radiator 13 in the differential mode feed structure, and indicates better radiation performance in this mode.

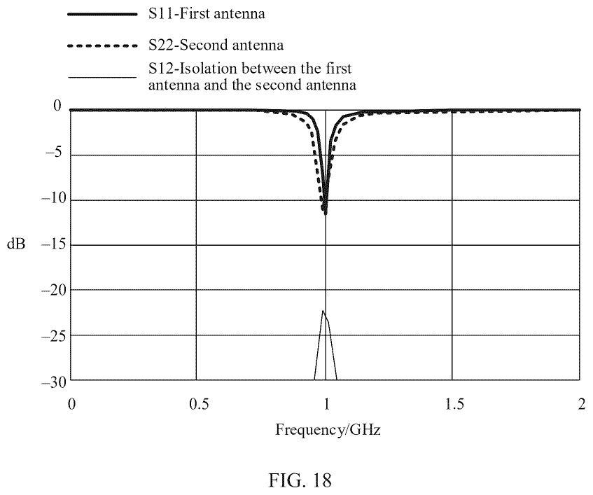

FIG. 18 shows a simulation result of a return loss and isolation of the first antenna and the second antenna when the antenna system as shown in FIG. 17 operates. A port of a first antenna may be a port 1, and a corresponding return loss may be S11. A port of a second antenna may be a port 2, and a corresponding return loss may be S22. Two-port isolation of the first antenna and the second antenna may be S12.

As shown in FIG. 18, deepest resonance points of the first antenna and the second antenna may be located near 1 GHz. As shown in S12, isolation between two antenna modes is the worst near 1 GHz, and is approximately −23 dB. Usually, for setting an antenna in a terminal device, a radiation requirement may be met with two-port isolation of less than −15 dB. Therefore, when the antenna system as shown in FIG. 17 operates near 1 GHz, independent and non-interfering operation of the two antenna modes can be implemented.

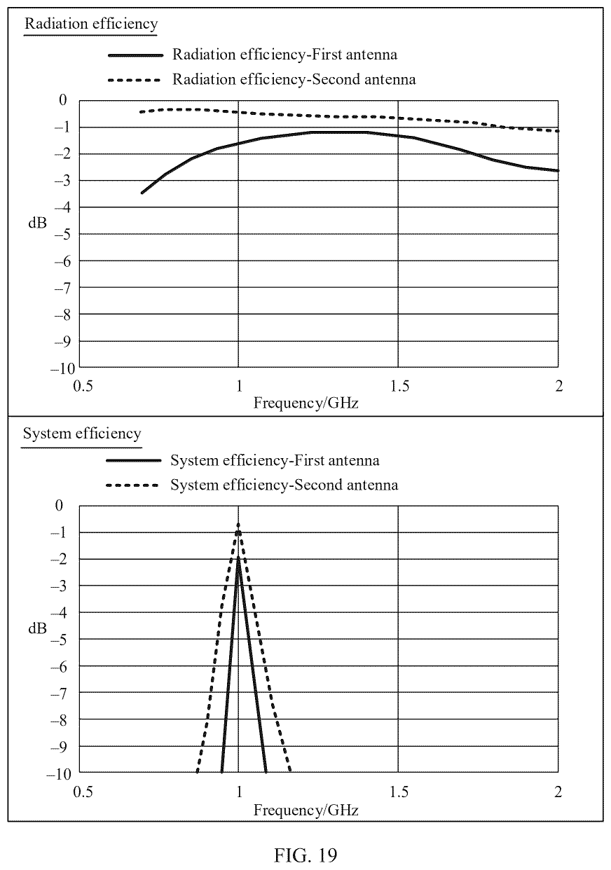

FIG. 19 shows schematic simulation of efficiency of a first antenna and a second antenna when the antenna system shown in FIG. 17 operates.

As shown in FIG. 19, from a perspective of radiation efficiency, a peak value of radiation efficiency of the first antenna is close to −1 dB. A bandwidth is greater than 500 MHz when the radiation efficiency is −2 dB. Radiation efficiency of the second antenna is higher, and a peak value exceeds −1 dB. A bandwidth is greater than 1 GHz when the radiation efficiency is −2 dB. From a perspective of system efficiency, in a current matching state, peak efficiency of the first antenna exceeds −2 dB, and peak efficiency of the second antenna exceeds −1 dB. Therefore, the antenna system shown in FIG. 17 can provide relatively good radiation performance regardless of from the perspective of radiation efficiency and the perspective of system efficiency.

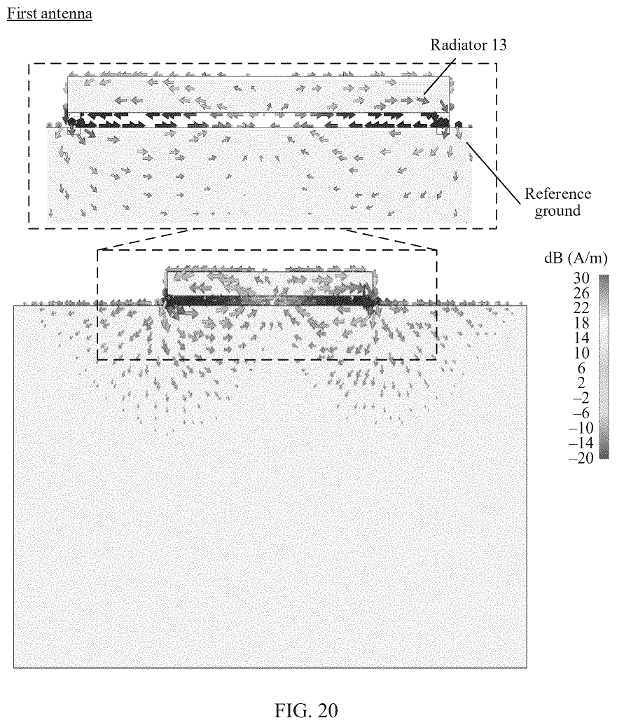

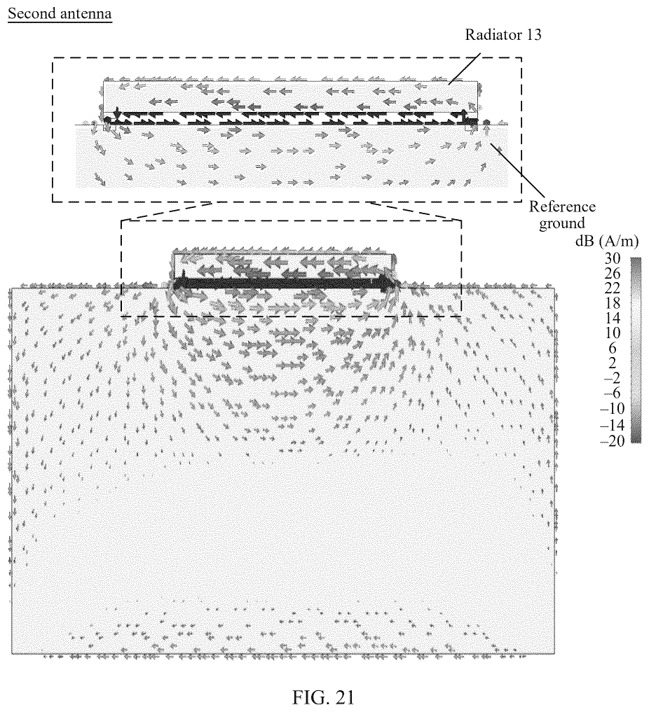

FIG. 20 and FIG. 21 show schematic current simulation of a first antenna and a second antenna when the antenna system shown in FIG. 17 operates.

As shown in FIG. 20, one current reversal point may be distributed on a radiator in a radiation mode corresponding to the first antenna. A current intensity distribution difference between various positions on the radiator 13 is insignificant (that is, a maximum current amplitude difference is relatively small). As shown in FIG. 21, in a radiation mode corresponding to the second antenna, same-direction currents may be distributed on a radiator, and there is no current reversal point.

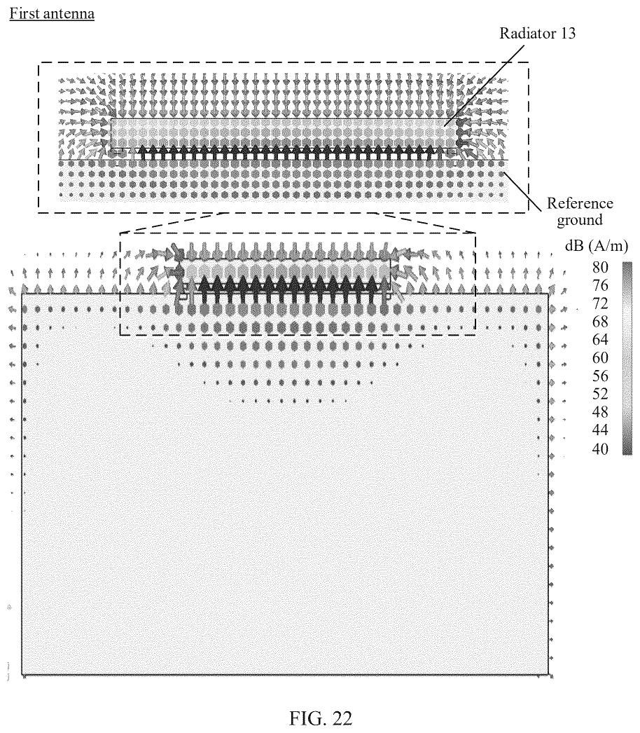

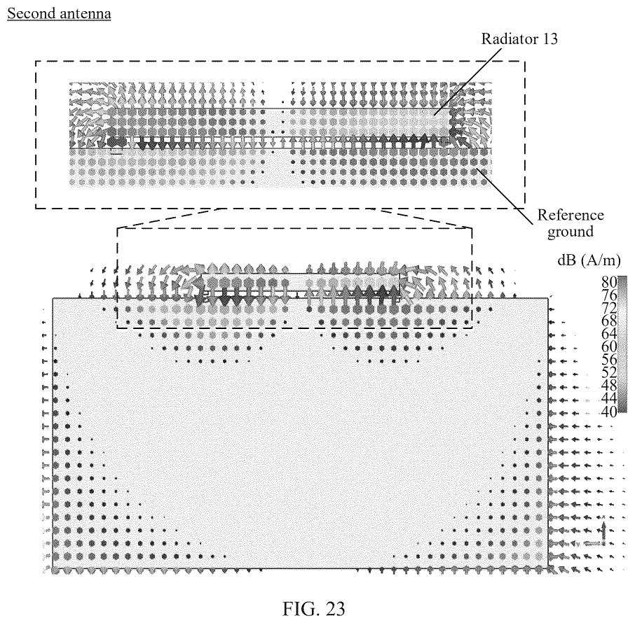

FIG. 22 and FIG. 23 show schematic electric field simulation of a first antenna and a second antenna when the antenna system shown in FIG. 17 operates.

As shown in FIG. 22, in a radiation mode corresponding to the first antenna, corresponding to current distribution as shown in FIG. 20, there is also a reverse position for electric field distribution near a radiator. As shown in FIG. 23, in a radiation mode corresponding to the second antenna, corresponding to current distribution as shown in FIG. 21, significant electric fields may be distributed in space between a radiator and a reference ground. Directions of the electric fields in this region are the same, and an intensity difference is relatively small (that is, a maximum electric field amplitude difference is relatively small).

Therefore, through the electrical parameter simulation shown in FIG. 20 to FIG. 23, it can be learned that when the antenna system shown in FIG. 17 operates, the radiation mode of the first antenna and the radiation mode of the second antenna can be separately obtained through excitation. In other words, in the joint arrangement and parallel connection distribution solution shown in FIG. 17, radiation of the first antenna shown in FIG. 6 or FIG. 7 can be realized, and radiation of the second antenna shown in FIG. 8 or FIG. 9 can also be realized, with high isolation between the two.

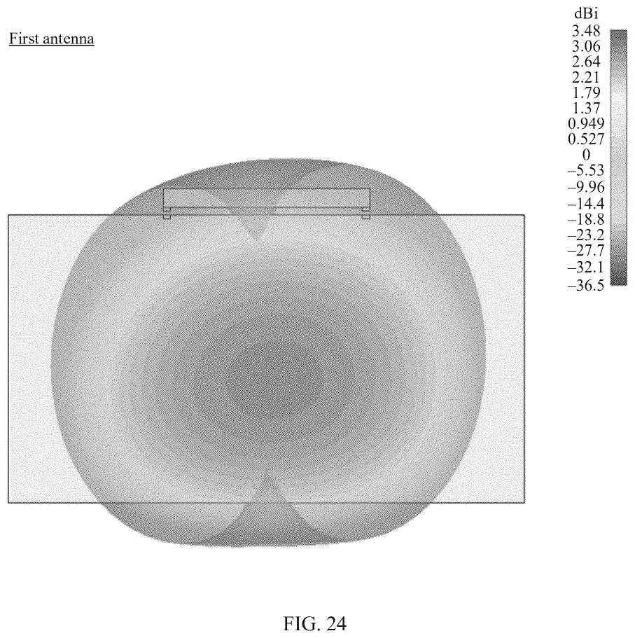

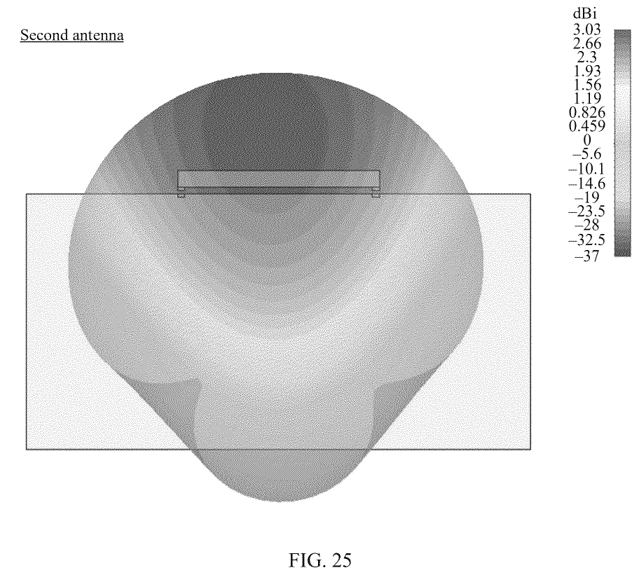

In addition, embodiments of this application further provide a pattern (as shown in FIG. 24) corresponding to the radiation mode of the first antenna and a pattern (as shown in FIG. 25) corresponding to the radiation mode of the second antenna when the antenna system shown in FIG. 17 operates.

With reference to the foregoing descriptions of FIG. 18 to FIG. 24, a person skilled in the art should accurately understand a radiation status of an implementation of the antenna system provided in embodiments of this application. The antenna system can achieve high isolation arrangement of the first antenna and the second antenna through joint setting and parallel connection distribution.

It should be understood that, with reference to the schematic descriptions of FIG. 10 to FIG. 16, and the example descriptions of FIG. 17 to FIG. 24, a person skilled in the art should understand that, in the arrangement, of the antenna system, constituted by series connection distribution, parallel connection distribution, opposite distribution, and orthogonal distribution of the first antenna and the second antenna that are implemented through joint arrangement or non-joint arrangement on the electronic device, an effect of high isolation between the first antenna and the second antenna can also be achieved. Therefore, the antenna system can be arranged so that when operating frequency bands of the first antenna and the second antenna at least partially overlap, the first antenna and the second antenna simultaneously provide relatively good radiation performance in the operating frequency band. Further, the antenna system can be enabled to provide better wireless communication quality in the operating frequency band.

It should be noted that, in all of the foregoing examples, the arrangement and an effect of the antenna system including the first antenna and/or the second antenna are described by using an example in which the electronic device (for example, a bar-type mobile phone) includes a display.

In some other embodiments, the arrangement of the antenna system including the first antenna and/or the second antenna may further be applied to other types of electronic devices. For example, the other types of electronic devices may include a foldable electronic device (which is briefly referred to as a foldable device).

In this example, the foldable device may be an electronic device provided with a folding axis. Through folding of the folding axis, the foldable device may have different folding states, for example, a closed state, an unfolded state, and a half-closed state between the closed state and the unfolded state.

In some implementations, a folding screen may be arranged on the foldable device, so that when a folding angle of the folding axis changes from small to large (corresponding to a process in which the foldable device is unfolded), the folding screen may be gradually unfolded to provide a display function to a user. In different implementations, the foldable device may include: a foldable mobile phone, a foldable tablet, or the like.

That the foldable device is the foldable mobile phone is used as an example. In some embodiments, at least two screens may be arranged on the foldable mobile phone. For example, that three screens are arranged on the foldable mobile phone is used as an example. Two screens, for example, a screen A and a screen B, connected to each other may be arranged on a side of the foldable mobile phone. In some other embodiments, the two screens connected to each other may alternatively be one foldable screen. For example, the screen A and the screen B may respectively correspond to two portions of a foldable flexible screen on two sides of the folding axis. Correspondingly, after the foldable mobile phone is folded, in a folded state, a third screen, for example, a screen C, may be arranged on the other side of the foldable mobile phone.

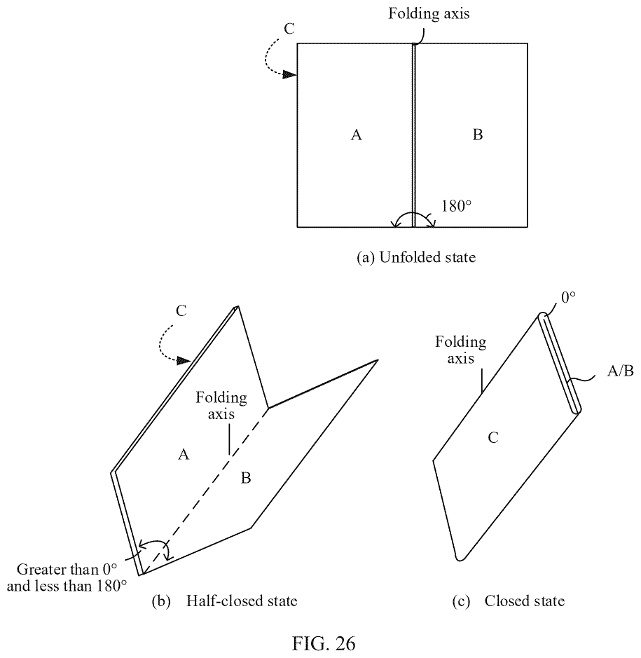

A folding state of the foldable mobile phone is briefly described with reference to FIG. 26. The screen A is abbreviated as A, the screen B is abbreviated as B, and the screen C is abbreviated as C. In some embodiments, a corresponding folding angle range of the folding axis of the foldable mobile phone in a folding process may be between 0 and 180 degrees.

As shown in (a) in FIG. 26, the folding angle of 180 degrees corresponds to the unfolded state of the foldable mobile phone. In the unfolded state, the screen A and the screen B on the foldable mobile phone may be unfolded on a same surface. The screen A and the screen B may be referred to as inner screens of the foldable mobile phone. In the unfolded state, the foldable mobile phone may provide the display function to the user through the screen A and/or the screen B.

As shown in (c) in FIG. 26, the folding angle of 0 degrees corresponds to the closed state of the foldable mobile phone. In the closed state, the screen A and the screen B on the foldable mobile phone may be closed close to each other. Correspondingly, the screen C may be presented to the user as an external appearance surface of the foldable mobile phone. The screen C may be referred to as an external screen. In the closed state, the foldable mobile phone may provide the display function to the user through the screen C.

In contrast to (a) in FIG. 26 and (c) in FIG. 26, as shown in (b) in FIG. 26, the folding angles between 0 degrees and 180 degrees correspond to the half-closed state of the folded mobile phone.

The arrangement of the antenna system provided in embodiments of this application is described below with reference to the foldable device shown in FIG. 26 by using an example in which an antenna system of the foldable device includes a first antenna and a second antenna, and operating frequency bands of the first antenna and the second antenna at least partially overlap. In some embodiments, the first antenna may have the composition as shown in FIG. 6, and the second antenna may have the composition as shown in FIG. 8.

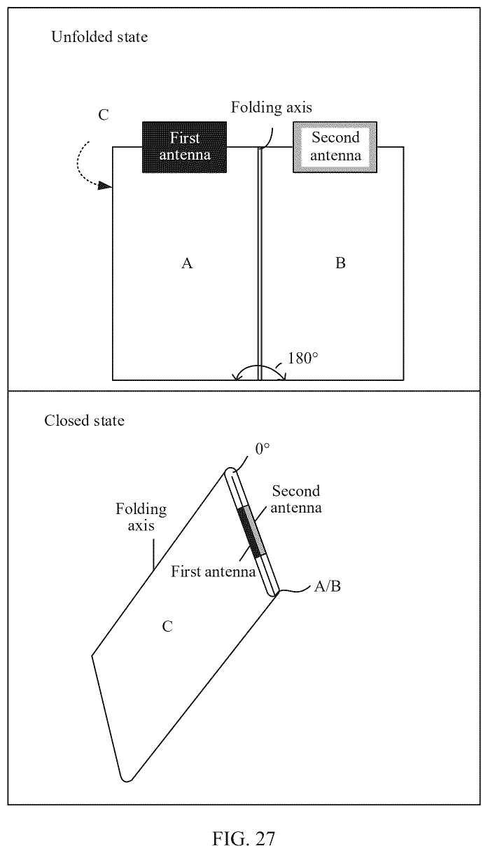

Refer to FIG. 27. That the first antenna is arranged in a projection region of a screen A, and the second antenna is arranged in a projection region of a screen B is used as an example.

In this example, the first antenna may be arranged at a middle position of a top edge, of the foldable device, on which the screen A is located. Similarly, the second antenna may be arranged at a middle position of a top edge, of the foldable device, on which the screen B is located.

In another embodiment, the foldable electronic device includes the first antenna and the second antenna as described above. The foldable electronic device includes a first portion and a second portion that are connected to each other and that can be folded or unfolded opposite to each other. The first antenna is arranged on the first portion of the foldable electronic device. The second antenna is arranged on the second portion of the foldable electronic device. The first antenna and the second antenna at least partially overlap when the foldable electronic device is in a closed state.

For example, the first portion may correspond to a projection portion of the screen A as shown in FIG. 27, and the second portion may correspond to a projection portion of the screen B as shown in FIG. 27.

In this case, in the unfolded state, the first antenna and the second antenna may be distributed in series connection. For a radiation effect that can be achieved, refer to the description of FIG. 15. That is, in the unfolded state, the first antenna and the second antenna in the antenna system may have relatively good isolation in the operating frequency band, so that the antenna system can provide relatively good radiation performance in the operating frequency band.

In the closed state, the first antenna and the second antenna are close to each other and are distributed in parallel connection. For an effect that can be achieved, refer to the description of FIG. 16. For example, in the closed state in FIG. 27, a position relationship between the first antenna and the second antenna may be interpreted as parallel connection distribution of a non-common arrangement. In this case, in the closed state, the first antenna and the second antenna in the antenna system may have relatively good isolation in the operating frequency band. In this way, the antenna system can provide relatively good radiation performance in the operating frequency band.

It should be noted that the arrangements of the first antenna and the second antenna as shown in FIG. 27 are merely examples, and do not constitute a limitation on the arrangement of the antenna system on the foldable device. In some other embodiments, the first antenna and/or the second antenna may alternatively be arranged on a side edge or a bottom edge, or a position of the first antenna and/or the second antenna on the edge may alternatively be a non-middle position. In another arrangement case, an actual position relationship between the first antenna and the second antenna in the unfolded state or the closed state may correspond to any one of the relative position relationships shown in FIG. 11 to FIG. 14, and an effect that can be obtained are similar. Details are not described herein.

It may be understood that the foregoing descriptions of the antenna system including the first antenna and the second antenna are provided by using an example in which lengths of radiators of the first antenna and the second antenna are less than one-half of a wavelength of the operating frequency band. In some other embodiments, the length of the radiator of the first antenna and/or the second antenna in the antenna system may alternatively be equal to one-half of the wavelength of the operating frequency band. For example, the first antenna may include a radiator whose length is equal to one-half of the wavelength of the operating frequency band, and a common mode feed structure arranged at two ends of the radiator. For another example, the second antenna may include a radiator whose length is equal to one-half of the wavelength of the operating frequency band, and a differential mode feed structure arranged at two ends of the radiator. In this case, similar to the analysis in the foregoing example, the first antenna and the second antenna can also obtain relatively good isolation, so that the antenna system provides relatively good radiation performance in the operating frequency band.

Although this application is described with reference to specific features and the embodiments thereof, apparently, various modifications and combinations may be made to them without departing from the spirit and scope of this application. Correspondingly, this specification and the accompanying drawings are merely example descriptions of this application defined by the appended claims, and are considered as having covered any of and all of modifications, variations, combinations, or equivalents within the scope of this application. Apparently, a person skilled in the art can make various modifications and variations to this application without departing from the spirit and scope of this application. In this case, if the modifications and variations made to this application fall within the scope of the claims of this application and their equivalent technologies, this application is intended to include these modifications and variations.

1. A terminal antenna system, used in an electronic device, wherein the terminal antenna system comprises a first antenna and a second antenna; operating frequency bands of the first antenna and the second antenna both comprise a first frequency band;
the first antenna comprises a first radiator, and a length of the first radiator is less than or equal to one-half of a wavelength corresponding to the first frequency band; and
a first feed point and a second feed point are respectively arranged at two ends of the first radiator, the first feed point and the second feed point are respectively coupled to two signal output ends of a common mode feed structure, the two signal output ends of the common mode feed structure have a same polarity, and two signals of the common mode feed structure are equi-amplitude in-phase signals;
the second antenna comprises a second radiator, and a length of the second radiator is less than or equal to one-half of the wavelength corresponding to the first frequency band; and
a third feed point and a fourth feed point are respectively arranged at two ends of the second radiator, the third feed point and the fourth feed point are respectively coupled to two signal output ends of a differential mode feed structure, the two signal output ends of the differential mode feed structure have different polarities, and two signals of the differential mode feed structure are equi-amplitude phase-inverted signals.

2. The terminal antenna system according to claim 1, wherein the length of the first radiator is less than or equal to one-fourth of the wavelength corresponding to the first frequency band.

3. The terminal antenna system according to claim 1, wherein the length of the second radiator is less than or equal to one-fourth of the wavelength corresponding to the first frequency band.

4. The terminal antenna system according to claim 1, wherein
the first radiator of the first antenna and the second radiator of the second antenna share a same third radiator.

5. The terminal antenna system according to claim 4, wherein
the first feed point and the third feed point are arranged close to each other, and the second feed point and the fourth feed point are arranged close to each other.

6. The terminal antenna system according to claim 5, wherein
the first feed point and the third feed point are arranged at a first end of the third radiator, and the second feed point and the fourth feed point are arranged at a second end of the third radiator.

7. The terminal antenna system according to claim 1, wherein
a periphery of the electronic device comprises a first edge, a second edge, a third edge, and a fourth edge that are successively adjacent; and
the first antenna is arranged on the first edge of the electronic device, the second antenna is arranged on the first edge of the electronic device, and projection of the first radiator and projection of the second radiator onto the first edge do not overlap each other;
the first antenna is arranged on the first edge of the electronic device, the second antenna is arranged on the second edge of the electronic device, and the first edge and the second edge are two adjacent edges;
the first antenna is arranged on the first edge of the electronic device, the second antenna is arranged on the third edge of the electronic device, and the first edge and the third edge are opposite edges; or
the first antenna is arranged on the first edge of the electronic device, the second antenna is arranged on the first edge of the electronic device, and projection of the first radiator and projection of the second radiator onto the first edge at least partially overlap.

8. The terminal antenna system according to claim 7, wherein
the first feed point and the second feed point of the first radiator are respectively coupled to two signal output ends of a first differential mode feed structure, instead of the two signal output ends of the common mode feed structure, the two signal output ends of the first differential mode feed structure have different polarities, and two signals of the first differential mode feed structure are equi-amplitude phase-inverted signals.

9. The terminal antenna system according to claim 7, wherein
the third feed point and the fourth feed point of the second radiator are respectively coupled to two signal output ends of a first common mode feed structure, instead of the two signal output ends of the differential mode feed structure, the two signal output ends of the first common mode feed structure have a same polarity, and two signals of the first common mode feed structure are equi-amplitude in-phase signals.

10. The terminal antenna system according to claim 1, wherein
a current reversal point is distributed on the first radiator when the first antenna operates; and
same-direction currents are distributed on the second radiator when the second antenna operates.

11. The terminal antenna system according to claim 1, wherein
the length of the first radiator is less than one-half of the wavelength of the first frequency band; and
a maximum electric field amplitude difference between the first radiator and a reference ground is a first value; the maximum electric field amplitude difference between the first radiator and the reference ground is a second value when the length of the first radiator is replaced with one-half of the wavelength of the first frequency band; and the first value is less than the second value.

12. The terminal antenna system according to claim 1, wherein
the length of the second radiator is less than one-half of the wavelength of the first frequency band; and
a maximum current amplitude difference on the second radiator is a third value when the second antenna operates; the maximum current amplitude difference on the second radiator is a fourth value when the length of the second radiator is replaced with one-half of the wavelength of the first frequency band; and the third value is less than the fourth value.

13. The terminal antenna system according to claim 5, wherein
the first radiator and the second radiator are arranged on a first edge of the electronic device;
a current perpendicular to a straight line on which the first edge is located on a reference ground is excited when the first antenna operates; and
a current parallel to the straight line on which the first edge is located on the reference ground is excited when the second antenna operates.

14. An electronic device, wherein the electronic device is provided with at least one processor and a radio frequency module;
the electronic device further comprises the terminal antenna system according to claim 1; and
when transmitting or receiving a signal, the electronic device transmits or receives the signal through the radio frequency module and the terminal antenna system.

15. A foldable electronic device, wherein the foldable electronic device comprises the terminal antenna system according to claim 1; and the foldable electronic device comprises a first portion and a second portion that are connected to each other and that can be folded or unfolded opposite to each other, the first antenna is arranged on the first portion of the foldable electronic device, and the second antenna is arranged on the second portion of the foldable electronic device; and
the first antenna and the second antenna at least partially overlap when the foldable electronic device is in a closed state.
